(19) United States
(12) Patent Application Publication
(10) Pub. No.: US 2004/0040400 A1
(43) Pub. Date: Mar. 4, 2004

(54) Driving school vehicle, double pedal device, pedal box, adjuster and driving instructor post for use in the driving school vehicle

(76) Inventor: Karlheninz Pilz, Munchen (DE)

Correspondence Address: WILLIAM COLLARD, COLLARD & ROE, P.C., 1077 NORTHERN BOULEVARD, ROSLYN, NY, 11576, US

(21) Appl. No.: 10/381,129

(22) PCT Filed: Sep. 20, 2001
(86) PCT No.: PCT/DE01/03627

(30) Foreign Application Priority Data
Sep. 22, 2000 (DE) 100471501
May 18, 2001 (DE) 201084112

(51) Int. Cl. G05G 11/00

(52) U.S. Cl. 74/480 R; 74/560

(57) ABSTRACT

The present invention relates to a driving school vehicle, a double pedal device with hydraulic coupling, a pedal box, actuators, and an instructor's post for use in the driving school vehicle. In particular, the hydraulic double pedal device for a driving school vehicle has at least one pedal on the driver's side, at least one pedal on the (99, 98, 97) on the passenger's side, and a hydraulic unit which couples the driver's side pedal with the passenger's side pedal in such a way that on operating the passenger's side pedal the driver's side pedal is also operated whereby the hydraulic device comprises at least one driver's side master cylinder arrangement, coupled to the driver's side pedal and at least one passenger's side master cylinder arrangement coupled to the passenger's side pedal and it is arranged symmetrically about an axis of symmetry (F), further comprising at least one pressure line (92) hydraulically connecting the driver's side master cylinder arrangement with the passenger's side mater cylinder arrangement, whereby a slider (63) mechanically coupled to the passenger's side pedal (99) and the passenger's side master cylinder arrangement (69, 70) to transfer force between the passenger's side pedal (99) and the passenger's side mater cylinder arrangement (69, 70), and a guide (65, 66) for it are provided.

The present invention relates to a driving school vehicle, a double pedal device having hydraulic coupling, a pedal unit, actuators, and a driving instructor post for use in a driving school vehicle.

In the WO 85/03369 a relevant pedal set assembly for a driving school vehicle is described. The known assembly has a first set of pedals having a brake pedal and a clutch pedal which are located on the driver's side in a vehicle and which are operated by the learner or driver during the driving lessons, and a second set of pedals again comprising a brake pedal and a clutch pedal which are located on the passenger's side and which are operated by the driving instructor during the driving lessons. The brake pedal on the instructor's side is coupled to the brake pedal on the driver's side via hydraulic means. In addition, the clutch pedal on the passenger's side is coupled to the clutch pedal on the driver's side via coupling means in the driving school vehicle. When the instructor operates the brake pedal or the clutch pedal, this operation or movement of the pedals is transferred to the corresponding pedals on the driver's side by the hydraulic means.

The driving instructor operates his pedals generally then if a dangerous situation or an emergency occurs, for instance, if the driver has overseen a necessary operation of the brake or in order to show the driver the appropriate operation of the pedals due to the cooperative operation of the instructor's pedals in an exemplified manner.

Each of the known hydraulic coupling means comprises a driving pressure cylinder having a piston rod that is mounted on the respective pedal on the instructor's side, a driven pressure cylinder having a piston rod as pressure cylinder means being connected to the corresponding pedal on the driver's side, and a fixed pressure line between both pressure cylinders.

Since the operation of a pedal on the instructor's side transfers the power or force of operating the pedal directly via the related piston rod to the column of liquid in the hydraulic coupling system, a buckling, bending or warping of the piston rod can occur which results in the piston rod and the associated pressure piston in the related pressure cylinder to become stuck, and, further, in consequence, results in degradation of the function of the hydraulic pedal coupling. This often insidiously or slowly advancing malfunction may lead in case of emergency, e.g. an emergency stop that has to be initiated by the driving instructor, to an accident.

It is, therefore, an object of the present invention to create a double pedal device of a driving school vehicle, which securely avoids a malfunction due to bending or warping of the piston rod of the hydraulic coupling means.

This object is solved by the driving school vehicle according to claim 116 and claim 117, and particularly by the double pedal device according to claim 1 or claim 49, by the pedal unit according to claim 27 or by the actuators according to claim 40 or claim 43 for use in the double pedal device.

Correspondingly, the double pedal device of the invention to be used in a driving school vehicle has at least one pedal on the driver's side, at least one pedal on the passenger's side, and hydraulic means coupling the pedal on the driver's side to the pedal on the passenger's side so that on operating the pedal on the passenger's side the pedal on the driver's side is operated, too, wherein the hydraulic means comprises at least a pressure cylinder means being coupled to the pedal on the passenger's side, at least one pressure cylinder means on the passenger's side being coupled to the pedal on the passenger's side and being symmetrical to an axis of symmetry, and at least one pressure pipe, line or conduit that couples the pressure cylinder means on the driver's side to the pressure cylinder means on the passenger's side hydraulically, wherein sliding means that are coupled mechanically to the pedal and the pressure cylinder means on the passenger's side for transferring power or force between pedal and the pressure cylinder means or mater cylinder means on the passenger's side, and guiding means on which the sliding means are supported preferably moveably such that only a force or force component acts in the direction of the axis of symmetry of the pressure cylinder means during the transfer of force from the pedal on the passenger's side to the pressure cylinder means.

The present invention has the decisive advantage that only horizontal forces, i.e. only forces in the direction of the axis of symmetry of the pressure cylinder means act, can act on the pressure cylinder means, and thus a bending or warping of the piston rod of the pressure cylinder means is avoided. Thus, the problems of the state of the art explained above are eliminated by the invention.

A pedal unit for use in a double pedal device, particularly on the passenger's side of a driving school vehicle, has at least one pedal and at least one pressure cylinder means being mechanically coupled to the pedal and being symmetrical to an axis of symmetry, wherein sliding means or a slider being mechanically coupled to the pedal and the pressure cylinder means for transferring power or force between the pedal and the pressure cylinder means, and guiding means are provided on which the sliding means is supported moveably or slideably such that only a force or a force component acts in the direction of the axis of symmetry of the pressure cylinder means during the transfer of force from the pedal to the pressure cylinder means.

Preferably, the guiding device comprises a guiding rod on which the slider or sliding means are supported moveably or slidably wherein the sliding means is supported on the guiding rod by a linear bearing or support. The use of linear bearing or support facilitates that the sliding means transfers only the linear horizontal component of the force onto the pressure cylinder device.

Preferably, the pedal unit on the passenger's side comprises at least two identical pressure cylinder means, the axes of symmetry thereof are arranged in parallel to each other and with distance to each other in the same plane. This so-called tandem cylinder facilitates the implementation of a big stroke of the pedal on the driver's side, wherein the pedal unit on the passenger's side has a small and compact size.

Preferably, the sliding means is made of plastic or synthetic resin, particularly polyethylene in order to provide a sufficient elasticity of the sliding means in the case of fluctuations of the temperature.

An actuator for use in the double pedal device of the invention and for engagement in a pedal on the driver's side of the driving school vehicle comprises a hydraulic pressure cylinder means and a moveable catch means that is moved by the pressure cylinder means of the actuator and is in engagement with the pedal on the driver's side.

The catch means has preferably a catch or carrier, which is covered at least partly by nylon or a similar material with low friction in order to avoid tilting or abrasion of the pedal lever at the catch.

A further actuator for use in the double pedal device of the invention and for engagement into a pedal on the driver's side of a driving school vehicle comprises a hydraulic pressure cylinder and a gear or gearing that converts a movement of the pressure cylinder of the actuator into a movement of the pedal being engaged in the actuator on the driver's side. A relatively small stroke or operation of the pressure cylinder on the driver's side can be converted by the gear into a big adjustment or movement of the pedal being coupled.

The present invention relates also to a double pedal device for use in a driving school vehicle, particularly with an automatic transmission.

When a driving school vehicle has an automatic transmission, then the set of pedals on the driver's side comprises an accelerator pedal and a brake pedal. A clutch pedal is omitted in a vehicle with automatic transmission. When the driver or learner operates the accelerator pedal wrongly, e.g. too strong operation of the accelerator in a curve etc., a dangerous situation may occur during a driving lesson. A double pedal device for a driving school vehicle should therefore allow the correction of a wrong operation of the accelerator pedal caused by the learner.

A double pedal device of the invention, which allows this correction, is mentioned in claim 49. Correspondingly, the double pedal device of the invention, which particularly may be used in a driving school vehicle having automatic transmission, has a driver's side accelerator pedal on the side of the learner, a passenger's side accelerator pedal on the side of the instructor, and coupling means that couple the driver's side accelerator pedal to the accelerator pedal on the passenger's side so that in the case of operation of the passenger's side accelerator pedal also the driver's side accelerator pedal is operated with increasing gas or acceleration, wherein, on the side of the instructor, an anti accelerator pedal or an anti gas pedal is provided in addition, and wherein the coupling means couple the accelerator pedal or gas pedal on the driver's side to the anti gas pedal on the passenger's side so that in the case of operation of the passenger's side anti gas pedal the driver's side accelerator pedal is operated with decreasing gas.

Thus, the double pedal device of the invention having anti gas has the remarkable advantage, that the instructor can perform a taking back of the gas by operating the anti gas pedal, and thus he can cancel or take back an inadequate operation of the gas pedal by the learner, whereby dangerous situations also during driving the driving school vehicle can be eliminated.

The coupling means of the invention may be, for instance, pure mechanical coupling means that, for instance, uses ropes or tackle lines. However, hydraulic means are preferred as coupling means which comprise accelerator pedal hydraulic means being engaged in the accelerator pedal on the driver's side, accelerator pedal hydraulic means on the passenger's side which are coupled to the accelerator pedal on the passenger's side, and anti gas pedal hydraulic means being coupled to the anti gas pedal on the passenger's side, and pressure pipe means connecting the gas pedal hydraulic means on the driver's side to the gas pedal hydraulic means on the passenger's side and to the anti gas pedal hydraulic means on the passenger's side hydraulically.

Preferably, the accelerator pedal hydraulic means on the driver's side, the accelerator pedal hydraulic means on the passenger's side and the anti gas pedal hydraulic means on the passenger's side each have at least one pressure cylinder means.

The anti gas pedal hydraulic means may have sliding means being mechanically coupled to the anti gas pedal on the passenger's side and to the associated pressure cylinder means for power transfer between the anti gas pedal and the pressure cylinder means, and guiding means on which the sliding means are supported in a sliding or movable manner.

In this case it would be preferred that only a force or a force component towards an axis of symmetry of the pressure cylinder means acts onto the associated pressure cylinder means in the case of transferring the force from the anti gas pedal to the associated pressure cylinder means. Hereby a sticking or a tilting of a pressure cylinder rod is prevented.

The anti gas pedal hydraulic means of the passenger's side preferably comprise two pressure cylinder means, the axes of symmetry thereof are arranged in parallel and in distance to each other in the same plane. This so-called tandem cylinder has the advantage that it facilitates converting a stroke of the anti gas pedal into a twice as big stroke of an anti gas actuator of the driver's side even in the case of very compact and small construction of the anti gas pedal hydraulic means.

Preferably, the accelerator pedal hydraulic means of the driver's side comprises actuator means on the driver's side of the vehicle, which engage in the driver's side accelerator pedal, and has at least one pressure cylinder means.

The actuating means may have a gas or accelerator actuator for increasing gas and an anti gas or anti accelerator actuator for taking back of gas.

Further, the accelerator pedal of the driver's side can be adjusted between a position of zero gas in which the gas or accelerator pedal is not operated, and a position of maximum gas in which maximum or full gas is adjusted. In this process, the anti gas actuator moves the driver's side accelerator pedal in the direction from the maximum gas position to the zero gas position if the passenger's side anti gas pedal is operated, and, in this case, the gas actuator moves the driver's side gas pedal in the direction from the zero gas position to the maximum gas position if the passenger's side gas pedal is operated.

The present invention relates also to an instructor's post or stand for use in a driving school vehicle, particularly a truck or a bus, comprising an instructor's seat, i.e. a seat of the vehicle to be used by the instructor, in the cap or cell of the driving school vehicle.

Known instructor's posts, particularly in trucks or busses, which are also used for sake of driving school, generally use the passenger's seat in the cap of the vehicle. The passenger's seat is designed in most cases, particularly in busses, only as auxiliary seat that provides only insufficient ergonomic conditions for the instructor. Further, the passenger's seat is distant from the seat on the driver's side so far that the instructor can control the learner during a driving lesson only with difficulty which can lead to dangerous situations during the driving school lessons. Thus, an instructor's post is desired which improves the ergonomic conditions of the driving instructor.

This object is solved by the driving school vehicle according to claim 116 or claim 117, and particularly by the driving instructor's post according to claim 72, claim 88, claim 94, claim 95, claim 101, or claim 114. Accordingly, the instructor's post of the invention for the driving school vehicle, particularly for use in a truck or a bus, has an instructor's seat, i.e. a seat in the vehicle for use by the instructor, in the cap of the driving school vehicle, and instructor's side pedal means in a double pedal device for operation by the instructor wherein the instructor's side pedal means are coupled to driver's side pedal means for controlling the driver's side pedal means of the double pedal device, and wherein a distance between the vehicle seat and the instructor's side pedal means can be adjusted. The instructor's post can be adapted to the dimensions or measures of the respective instructor by means of adjustment ability of the distance between the instructor's seat and the pedal means. Thereby, the instructor has a more relaxed and more convenient position of the body during the driving lesson, which contributes to an improved power of concentration of the instructor.

The vehicle seat of the instructor and/or the pedal means of the instructor's post can be arranged in longitudinal direction of the driving school vehicle in the cap of the driving school vehicle in a shiftable or moveable manner for changing the distance between the vehicle seat and the instructor's side pedal means.

The instructor's seat may be arranged preferably on or in rails or grooves in the floor pan of the vehicle, which extend in parallel to each other and then the instructor's seat can be shifted thereon. The instructor's side pedal group can be fixed to the base or floor pan of the vehicle or the pedal means can be formed shiftably or in an easily moveable manner.

For instance, the pedal means may be mounted on the floor pan of the vehicle by means of an easily releasable Velcro fastener. If the distance between the pedal means and the seat should be changed, the Velcro fastener may easily released and the pedal means can be arranged in the new position with changed distance as desired. The surface of the Velcro fastener on the floor pan of the vehicle is formed to be bigger with regard to the surface than the adhering surface of the Velcro fastener on the pedal means in order to allow a corresponding adjustment of the distance between seat and pedal group.

Preferably, the instructor's seat has a seat surface that is arranged more higher than the seat surface of the driver's seat in order to facilitate a better view of the learner's driving action and driving operation by the instructor.

The instructor's seat has preferably a seat portion or member and pneumatic spring action means supporting the seat portion. The pneumatic spring or air suspension allows a convenient and comfortable sitting of the instructor and, in addition, adjusting the height of the seat by a height adjusting means for adjusting the height of the instructor's seat above the driving school vehicle floor pan.

The instructor's seat may also comprise a backrest member and a pivoting arrangement for adjusting the inclination of the backrest member relative to the seat surface of the seat portion whereby an additional adjusting possibility and, thus, a even more comfortable or yet more ergonomic sitting position of the instructor can be attained.

The instructor's side pedal means are preferably coupled to the driver's side pedal means via hydraulic means. Further, the hydraulic means may have a flexible pressure line, pipe or conduit for transferring an actuating pressure to the driver's side pedal. The use of flexible pressure lines in the hydraulic means has the advantage that the instructor's side pedal means may be easily shifted or displaced for adapting to the instructor's seat without requiring mounting efforts for the rearrangement of coupling lines between the pedal groups.

The instructor's seat has preferably a rack or support on which the instructor's side pedal means is mounted. This has the advantage that the instructor's post having a seat and pedal means is formed in unit that can be mounted in one step of work into the driving school vehicle and it can be also demounted easily again if required. Then a position of the pedal means relative to the seat on the rack, which has been adjusted once, can be maintained. The same instructor then must not readjust the instructor's post each time when the instructor's post is mounted in the vehicle. Here it is also preferred that the rack comprises means for adjusting the distance between the instructor's seat and the instructor's side pedal means or that the rack can be adjusted easily.

The instructor's side pedal means may be shiftably mounted on the rack for adjusting the distance between the instructor's seat and the instructor's pedal means.

The rack for the instructor's side pedal means is preferably mounted on the seat portion of the instructor's seat. This facilitates that the pedal means always maintain the adjusted position relative to the seat surface even when the seat itself should be readjusted in height.

The rack may have a guide in which the instructor's side pedal means can be moved or locked. In addition, the instructor's side pedal means can be inserted into the guide or it can be removed there from.

The present invention relates also to an instructor's post or stand for a driving school vehicle, particularly a truck or a bus, having a vehicle seat for the instructor in the driver's cap of the driving school vehicle and pedal means for operation by the instructor wherein the instructor's side pedal means are coupled to driver's side pedal means for controlling the driver's side pedal means and wherein display means, particularly an electronic display, is provided which shows to the instructor at least a view of the surroundings of the driving school vehicle.

The display means has the remarkable advantage that the instructor may catch the current driving situation completely even when his angle of view to the exterior mirror is different to the learner's angle of view or even only restricted. The instructor can observe, for instance, the blind angle by using the display device. Thus, this contributes remarkably in making the driving schoolwork more safely.

The display may have several display fields each of which can show a different view of the surroundings of the driving school vehicle. For instance, a left side, right side view of the surroundings, a rear view an/or a front view of the driving school vehicle and of its surroundings may be shown whereby the instructor's possibilities for observing can be improved.

The instructor's post has preferably coupling means, for instance, an easily pluggable connection or connector having corresponding plugs and cables, which connect or couple the display means to a video camera or to several video cameras mounted on the driving school vehicle which catch the view(s) of surroundings of the driving school vehicle for displaying the views of surroundings on the display means.

The display means are preferably fixed to the instructor's seat in order to attain an instructor's post in one unit. The support for the display means may be mounted on the seat member of the instructor's seat.

The present invention also relates to an instructor's post or an instructor's seat device for use in a driving school vehicle, particularly a truck or a bus, having a vehicle seat for the instructor in the cap of the vehicle wherein the instructor's seat is arranged or mounted in a middle area between a driver's seat and a passenger's seat on the floor pan or chassis base group of the driving school vehicle.

Known instructor's posts, particularly in trucks or busses, which also are used for the purposes of driving schools, use generally the passenger's seat in the driver's cap of the vehicle. The passenger's seat is in most cases only formed as auxiliary seat, particularly in busses, which only offers insufficient ergonomic conditions for the instructor. Further, the passenger's seat is distant to the seat on the driver's side such far that the instructor can control the learner during a driving lesson only with difficulties, which may lead to dangerous situations during the driving lessons. Therefore, an instructor's post is desired which improves the ergonomic conditions of the instructor and, therefore, enhances the security during the driving lessons.

This object is solved by the instructor's post according to claim 94, claim 95, claim 101 or claim 114. Correspondingly the instructor's post of the invention to be used in a driving school vehicle, particularly in a truck or in a bus, has an instructor's side pedal device to be operated by the instructor wherein the pedal means is coupled to driver's side pedal means for controlling the driver's side pedal means which together form a double pedal device, and it has at least one pedal, and a footrest for the instructor which is arranged in a region above the pedal.

The instructor's post of the invention for a driving school vehicle, particularly a truck or a bus, has an instructor's side controlling unit, which is coupled to an electrical arrangement or device of the driving school vehicle for controlling the driving operation.

The instructor's post or the double pedal device of the invention for a driving school vehicle particularly a truck or a bus has instructor's side pedal means for operation by the instructor, wherein the pedal means are coupled to a driver's side pedal means for controlling the driver's side pedal means and wherein a pedal linkage of the pedal means is surrounded by a folded and flexible sleeve or cover.

Further advantageous embodiments of the present invention are mentioned in the dependent claims.

Further advantages, advantageous embodiments and uses of the present invention result from the following description of preferred and exemplified embodiments of the invention in connection with the enclosed drawings, which show:

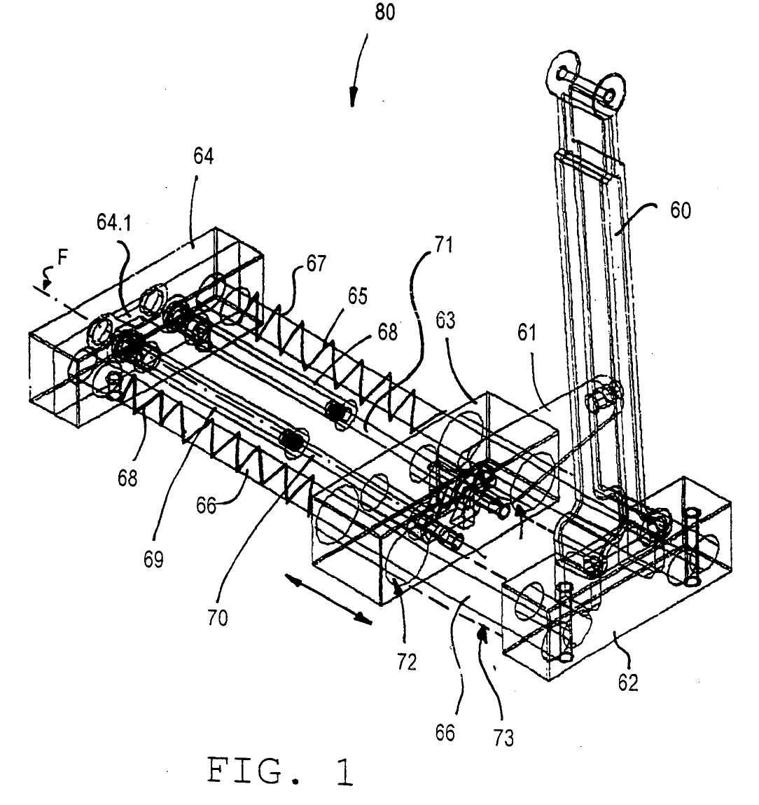

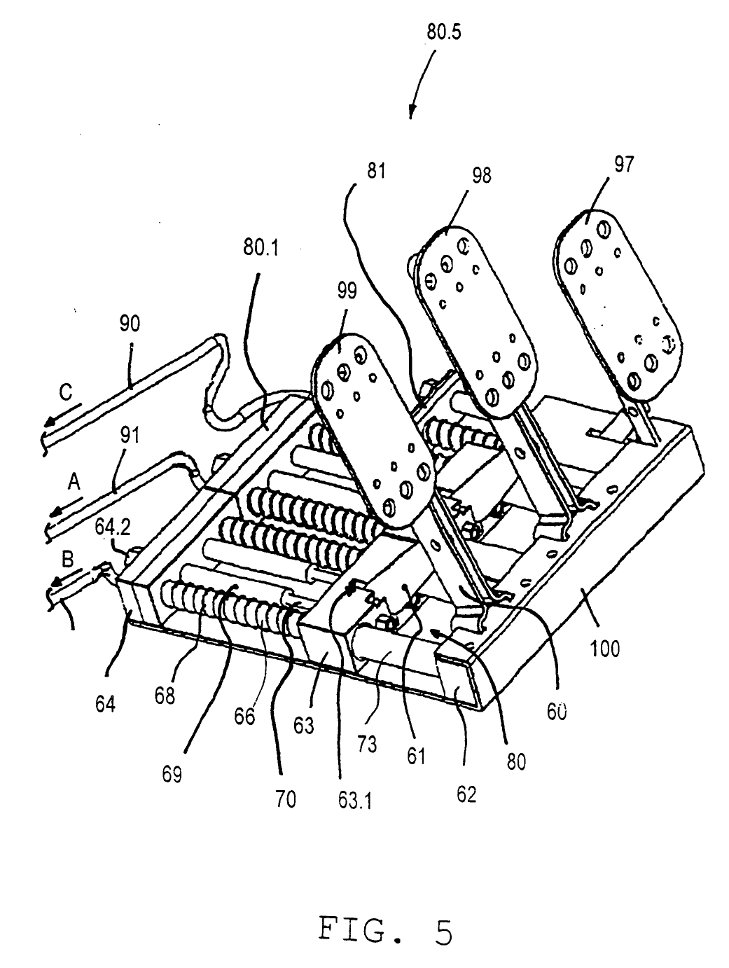

FIG. 1 a schematic perspective view of a preferred pedal unit in the double pedal device of FIGS. 4 and 5 according to a preferred embodiment of the invention;

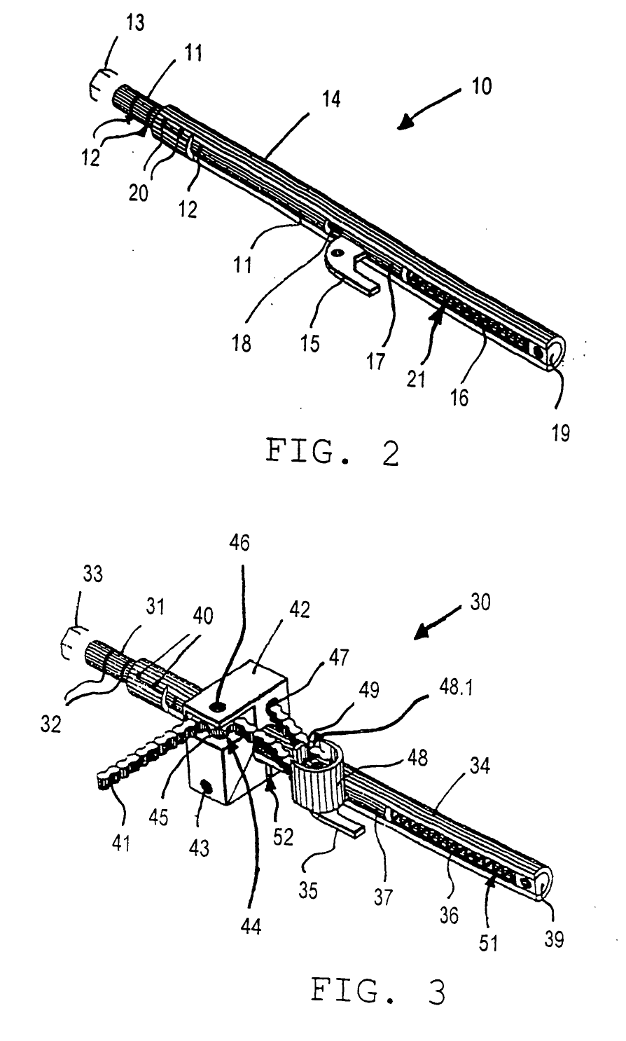

FIG. 2 a perspective, partly cut away and separated view of a preferred actuator on the driver's side for use in the double pedal device of FIGS. 4 and 5 according to a preferred embodiment of the invention;

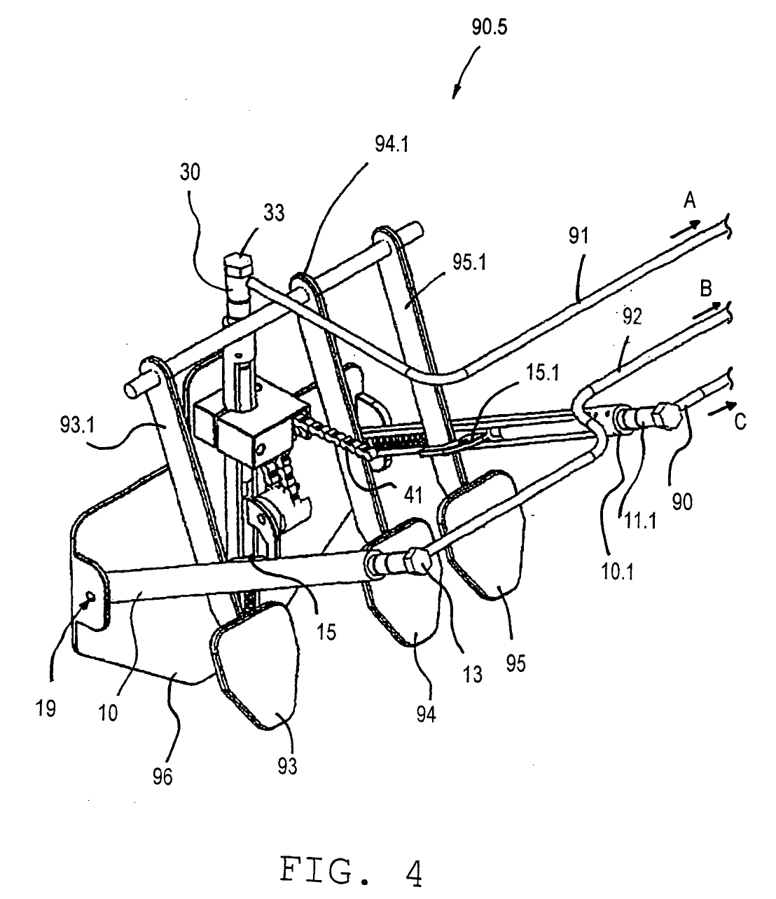

FIG. 3 a separated, partly sectional perspective view of a further preferred actuator on the driver's side of the vehicle for use in the double pedal device of FIGS. 4 and 5 according to a preferred embodiment of the invention;

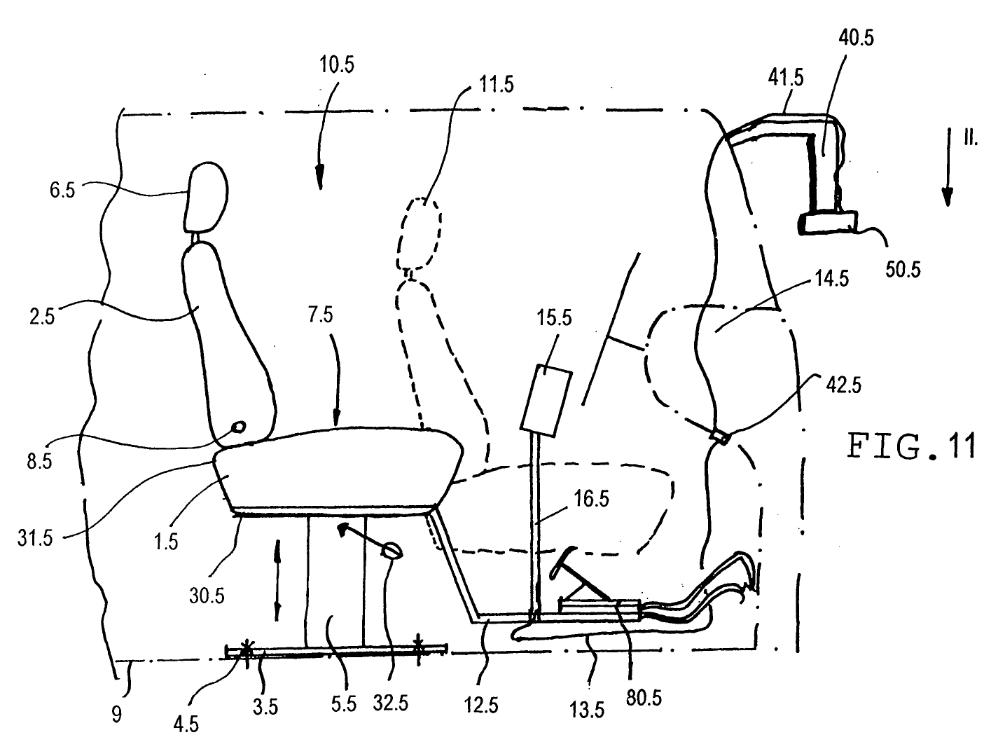

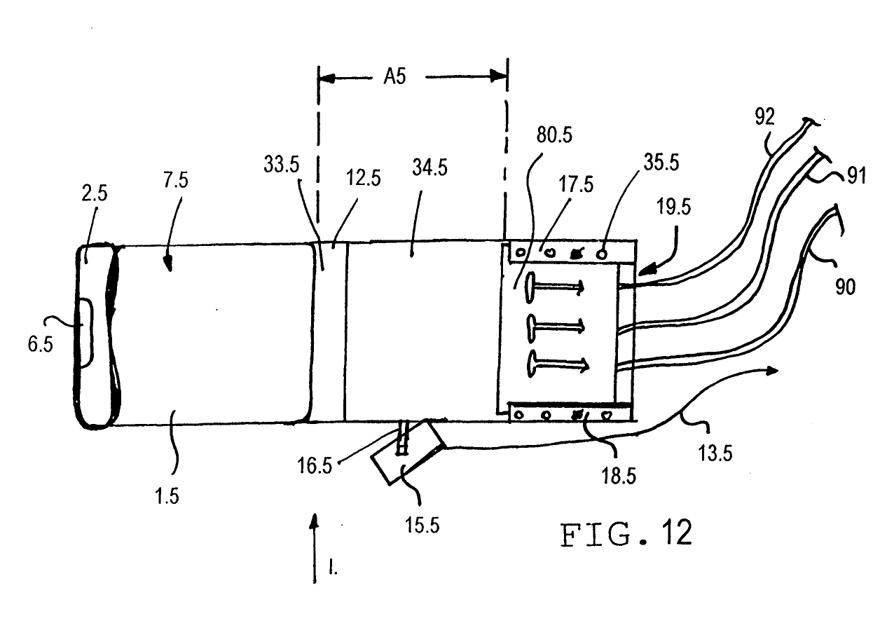

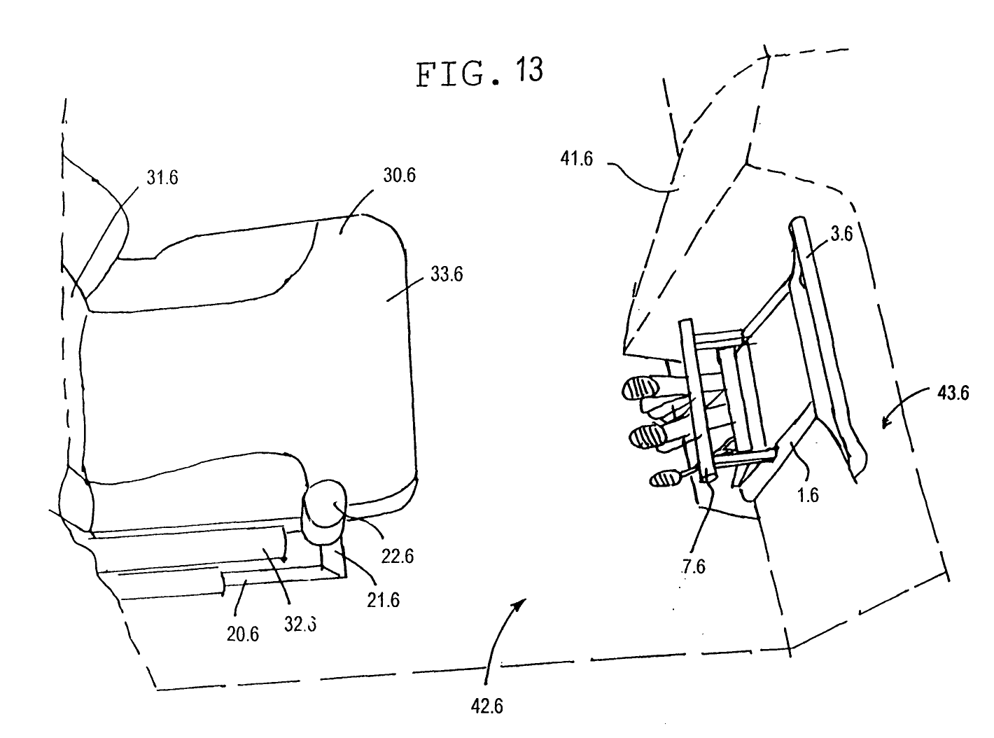

FIG. 4 a perspective view of the driver's side pedal means of a preferred embodiment of the double pedal device of the invention, which may be used in the instructor's post of FIGS. 11 and 12 and also in the instructor's post of FIGS. 13, 14 and 15, inclusively the components of FIGS. 1, 2 and 3;

FIG. 5 a perspective view of the passenger's side pedal means of a preferred embodiment of the double pedal device of the invention wherein both pedal means of FIGS. 4 and 5 are connected to each other at the interfaces A, B and C and wherein the passenger's side pedal means and the instructor's side pedal means may be used in the instructor's post of FIGS. 11 and 12 and also in the instructor's post of FIGS. 13, 14 and 15, inclusively the components of FIGS. 1, 2 and 3;

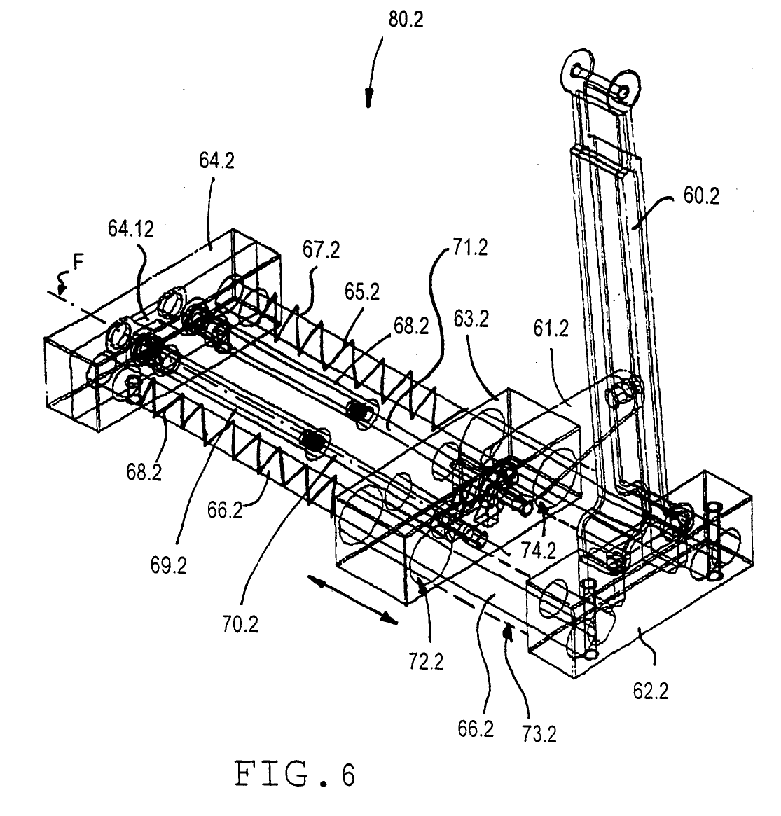

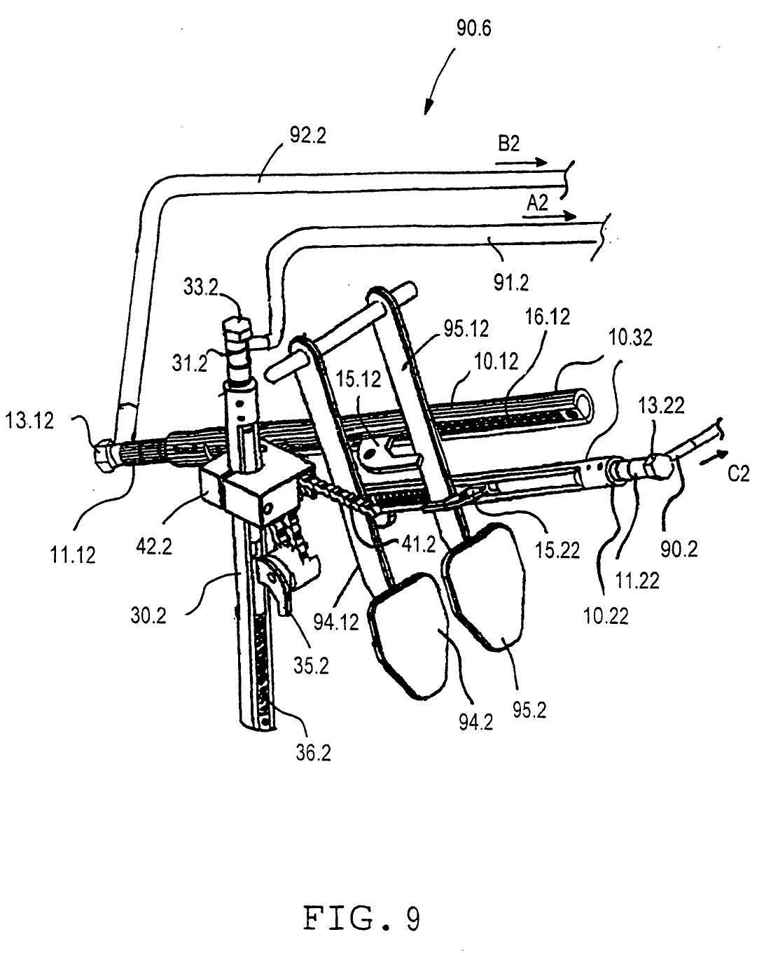

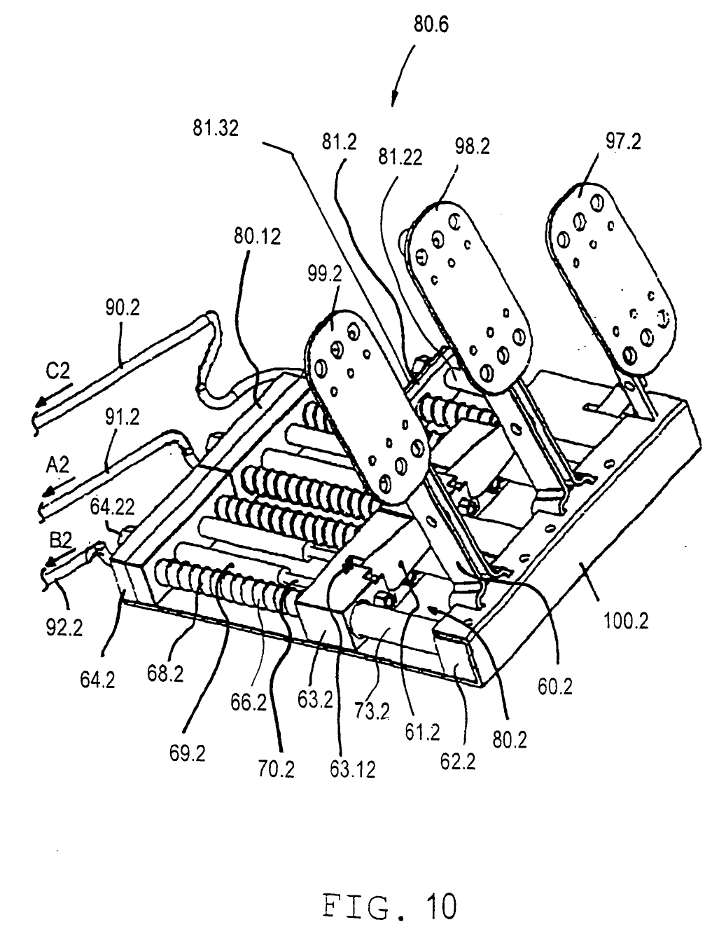

FIG. 6 a schematic perspective view of a preferred pedal unit to be used in the double pedal device with anti gas of FIGS. 9 and 10 according to a further preferred embodiment of the invention;

FIG. 7 a perspective partly cut off and separated view of an actuator on the driver's side for use in the double pedal device of FIGS. 9 and 10 according to a preferred embodiment of the invention;

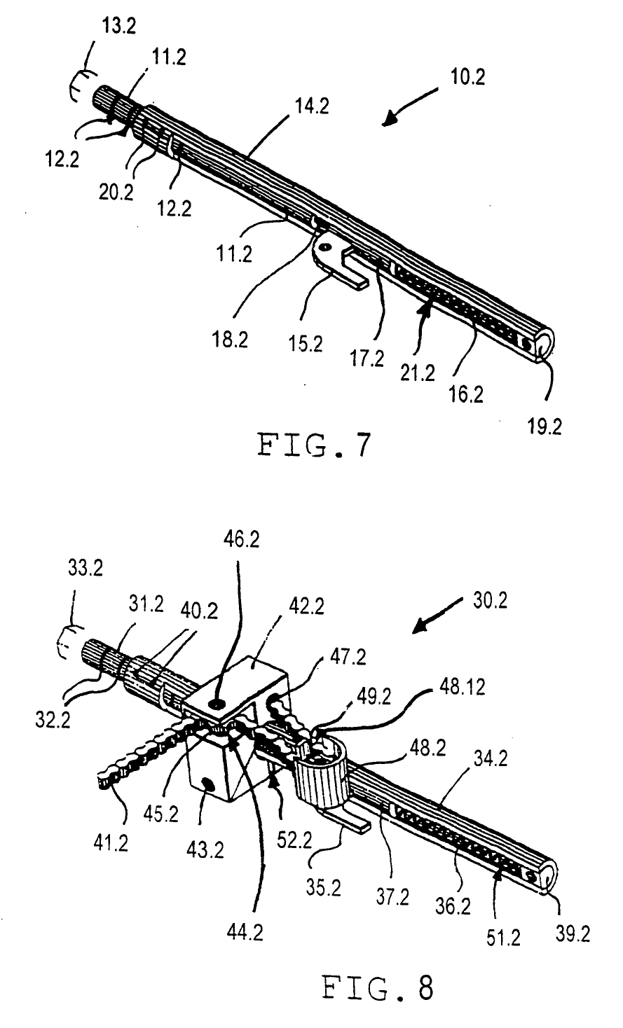

FIG. 8 a separated partly cut off perspective view of a further actuator on the driver's side of the vehicle for use in the double pedal device of FIGS. 9 and 10 according to a preferred embodiment of the invention;

FIG. 9 a perspective view of the driver's side pedal means of a further preferred embodiment of the double pedal device of the invention which may be used in the instructor's post of FIGS. 11 and 12 and also in the instructor's post of FIGS. 13, 14 and 15, inclusively the components of FIGS. 6, 7 and 8;

FIG. 10 a perspective view of the passenger's side pedal means of the further preferred embodiment of the double pedal device of the invention with anti gas pedal wherein both parts according to FIGS. 9 and 10 are connected to each other at the interfaces A2, B2 and C2 and wherein the passenger's side pedal of FIG. 9 may also be used in the instructor's post of FIGS. 11 and 12 and also in the instructor's post of FIGS. 13, 14 and 15, inclusively the components of FIGS. 6, 7 and 8;

FIG. 11 a schematic lateral view of the driver's cap of a driving school vehicle with a mounted instructor's post according to a preferred embodiment of the invention, to be seen in the direction of the arrow I of FIG. 12;

FIG. 12 a schematic plane view of the separated instructor's post of FIG. 11, to be seen in the direction of the arrow II of FIG. 11;

FIG. 13 a perspective plane view of an instructor's post according to a preferred embodiment of the invention comprising an instructor's seat, a controlling unit and a rack for an instructor's side pedal means wherein the instructor's post is mounted in a cap of a driving school vehicle;

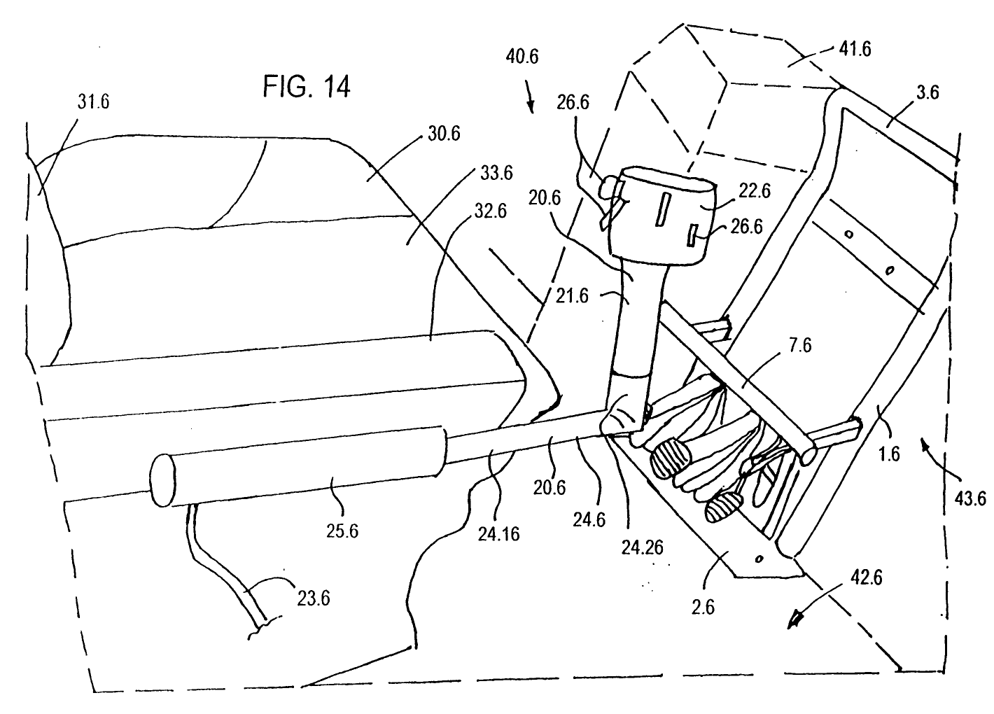

FIG. 14 a perspective view of the instructor's post of the embodiment of the invention of FIG. 13 being seen from the passenger's side of the driving school vehicle; and

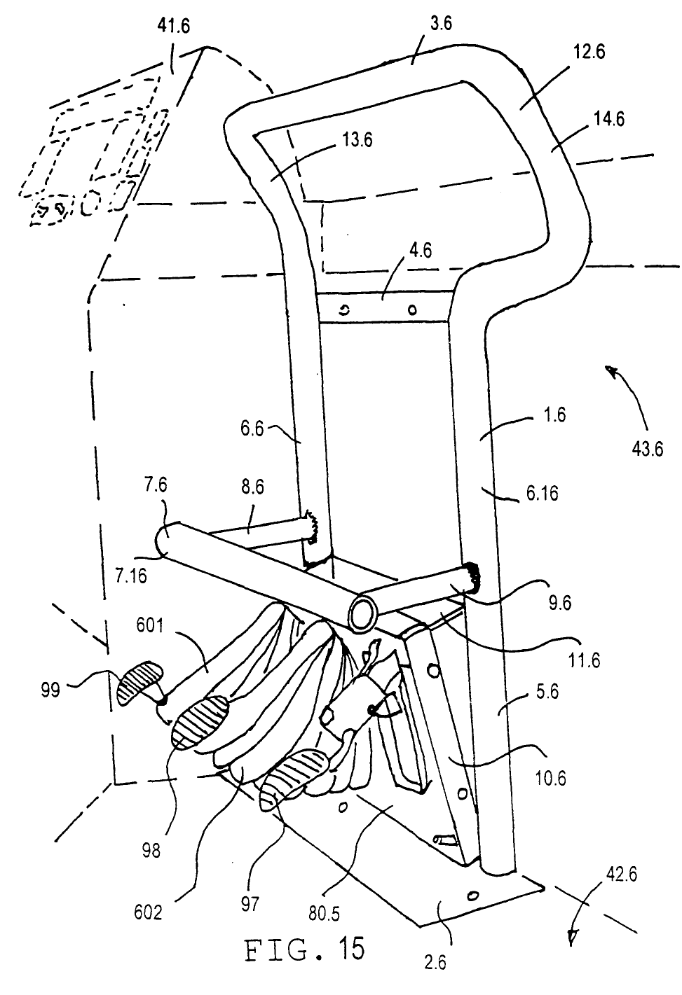

FIG. 15 a perspective detailed view of the embodiment of FIGS. 13 and 14 wherein the rack for the instructor's side pedal means is shown in more detail.

FIG. 2 shows an actuator 10 in a separated perspective and partly cut off view. The actuator 10 comprises a cylindrical hollow actuator casing 14 being opened at its end, a pressure cylinder 11 that extends at least partly within the cavity of the actuator casing 14 and concentrically to an axis of the actuator casing 14, a piston rod 18 which is coupled to the pressure cylinder 11 within the cavity of the actuator casing 14 by means of a pressure cylinder piston not shown in the drawing and which is connected to a catch cylinder 17 at its other end in a fixedly manner, which is fitted in the actuator casing 14 in a slideable or moveable manner and which can be moved back and forth along the axis of the actuator casing 14 within the cavity, and a spring 16 extending between the other end of the actuator casing 14 concentrically to the axis of the actuator casing 14, i.e. in more detail between the catch cylinder 17 and an actuator support 19 made of synthetic resin, which terminates the other end of the actuator casing 14.

The pressure cylinder 11 is made of stainless steel or aluminium and it is hydraulically coupled to an associated pressure pipe or pressure line of the hydraulic coupling means by means of a hollow screw 13 being fixed at the end of the pressure cylinder 11 and having a screwable thread socket. The pressure cylinder 11 is arranged concentrically to the axis of the actuator casing 14 within the cavity or hollow space of the actuator casing 14. The pressure cylinder 11 has grooves 12 extending radially and annularly on the exterior surface of the pressure cylinder 11 and at its end towards the hollow screw 13. Pins 20 engage in the grooves 12, which pass through corresponding holes in the wall of the actuator casing 14 in order to fix the pressure cylinder 11 on the actuator casing 14.

According to FIG. 2, the pressure cylinder 11 has five of these radial grooves 12 on the whole wherein two neighbouring grooves cannot be seen in FIG. 2 since they are covered by the whole of the actuator casing 14, but they are engaged in both fixing pins 20 shown.

During establishing the actuator 10, one can determine by means of the radial grooves 12 and the pins 20 cooperating with the grooves how far the pressure cylinder 11 extends into the actuator casing 14 or projects from the end of the actuator casing whereby the position of the catch 15 along the actuator casing 14 in its initial position can be adjusted in which no pressure acts on the pressure cylinder 11, and therefore the maximum stroke of the catch 15 of the actuator 10 in adaptation to the respectively given construction of the associated pedal can be adjusted. Thus, the actuator 10 can be adapted to the pedals of different types of vehicles and to vehicles having different stroke of pedal.

Within the pressure cylinder 11, there is located a pressure piston (not shown) on which the hydraulic pressure existing in the pressure cylinder acts. The pressure piston is sealingly and moveably supported within the pressure cylinder 11 so that hydraulic liquid cannot escape from the pressure cylinder 11. The pressure piston is connected to a piston rod 18 within the pressure cylinder 11 which projects from the pressure cylinder 11 within the actuator casing 14 and which extends concentrically to the axis of the cylindrical actuator casing 14.

At the other end of the piston rod 18, the catch cylinder 17 is accommodated which is moveable back and forth within the actuator casing 14 along the axis of the actuator casing 14 and which moves depending on the pressure of the hydraulic pressure cylinder 11. The catch cylinder 17 can be made of stainless steel, aluminium, or a synthetic resin and is formed preferably in a solid manner.

The catch 15 is fixed to the external surface of the catch cylinder 17 and it has a hooked contour if seen in the front elevation wherein the opening of the hooked catch 15 points to the end of the actuator casing 14 with the actuator support 19. The catch 15 has a catch leg extending in parallel to the axis of the actuator casing 14, and a catch basis mounted on the catch cylinder 17. The catch may be provided with a synthetic resin, particularly nylon, on its surface.

The opening of the catch, i.e. the region between the external wall of the actuator casing 14 and the surfaces of the catch 15 which are adjacent to the opening of the catch, is formed so that the pedal lever, to which the actuator 10 is coupled, fits into the catch opening of the catch 15 in order to assure a secure operation of the associated pedal or pedal lever.

The spring 16 is accommodated in the cavity of the actuator casing 14 between the actuator support 19 and the catch cylinder 17, which is formed as a compression spring and which pushes the moveable catch cylinder in the cavity of the actuator casing 14 towards the pressure cylinder 11.

The actuator support 19 is fitted into the cavity of the actuator casing 14 at the corresponding end of the actuator casing 14 and it terminates the corresponding end of the actuator casing 14. The actuator support 19 serves as an opposing or counter support of the spring 16 and for mounting or fixing the actuator 10 on the chassis of the vehicle on the driver's side in the region of the pedal or on a basic plate 96 separately provided which is mounted or accommodated in the area of the pedal of the vehicle on the driver's side. The actuator support 19 can also be formed as articulation or joint in order to mount the actuator 10 on the chassis or the basic plate 96 in the region of the pedal on the driver's side in a jointed or articulate manner.

A slot 21 is formed in the wall of the actuator casing 14 which extends in parallel and along the axis of the actuator casing 14 and through which the catch 15 of the catch cylinder 17 projects from the actuator casing 14. The free width of the slot 21 or of the recess is adapted to the thickness or dimension of the catch 15 so that the catch 15 is able to move freely back and forth. The length of the slot 21 corresponds at least to the maximum allowable stroke of the catch 15. The slot 21 may be formed with regard to its dimension so that a guiding of the catch 15 is carried out by the walls of the slot.

When the pressure cylinder 11 of the actuator 10 is provided with pressure by operation of the associated pedal on the passenger's side, i.e. by the driving school instructor, the piston rod 18 and thus the catch cylinder 17 and the catch 15 are shifted towards the actuator support 19 against the compression force of the spring 16 whereby the pedal being engaged is operated on the driver's side. When subsequently the operation of the pedal on the passenger's side is taken back, also the hydraulic pressure in the pressure cylinder 11 decreases and the catch cylinder 17 together with the catch 15 is shifted or moved in the opposite direction, i.e. towards the pressure cylinder 11, by the spring 16 until a balance between the pressure force of the pressure cylinder 11 and the compression force of the spring 16 is provided. When the instructor takes back the pedal pressure or the pedal action yet further until a pedal operation on the passenger's side does not longer exist, the spring 16 shifts or pushes the catch cylinder 17 along with the catch 15 more and more into the direction the pressure cylinder 11 until the catch 15 reaches its starting or initial position, in which there isn't any pressure action by the pressure cylinder 11, but only a pressure is given by action of the spring 16.

FIG. 3 shows an actuator 30 in a view corresponding to FIG. 2. The actuator 30 has an actuator casing 34 having a pressure cylinder 31 with grooves 32 extending radially on the surface, and a terminating hollow screw 33, a catch 35 or support which projects from the actuator casing 34, a spring 36, which is formed as a compression spring, and a moveable cylinder 37 in the interior of the actuator casing 34 which is connected to a piston rod (not shown in FIG. 3) on one of its ends, wherein the piston rod extends into the pressure cylinder 31 and is connected to a pressure piston in the interior of the pressure cylinder 31. The pressure cylinder 31 can be adjusted and fixed on the actuator casing 34 by the grooves 32, and the fixing pins 40.

The configuration and the function of the elements 31, 32, 33, 34, 36 and 39 of a actuator support and of a slot 51 are identical to the configuration and function of the corresponding elements of the actuator 10 which is shown in FIG. 2. Concerning a detailed description of the configuration and the function of these elements, it is referred to the explanations mentioned above with regard to FIG. 2. In contrast to actuator 10 in FIG. 2, the actuator 30 in FIG. 3 does, however, have not any catch, but it is connected to an associated pedal lever or driver's side pedal by a chain 41 or linkage. The configuration or construction of the actuator 30 having a chain 41 will be described in detail in the following.

A chain support 42 is set on or pushed on the cylindrical actuator casing 34 of the actuator 30, which is formed as a rectangular cuboid. The chain support 42 is clamped fixedly on the actuator casing 34 of the actuator 30 by means of a clamping screw 43. In FIG. 8, a small gap 52 can be seen within the lower area of the chain support 42, which enables clamping by the clamping screw 43 on the circumference of the actuator casing 34. Before clamping of the chain support 42, the chain support 42 may be shifted on the circumference of the cylindrical actuator casing 34 and, thus, it can be adjusted in its final position. By clamping, the chain support 42 is fixed in its position on the actuator casing 34 and along the length of the actuator casing 34. In the upper portion of the rectangular chain support 42 a compartment 44 is provided which is opened to the outside and accessible from the outside at the shown corner of the chain support 42. In the compartment a first gear wheel 45 or pinion gear or toothed wheel is arranged on a shaft 46 or arranged rotateably together with the shaft 46. The chain 41 is held on the chain support 42 with a chain mount 47 at one of its ends.

A support 35 is connected to the cylinder 37, which projects out of the actuator casing 34 through the slot 51. As support 35 the hooked catch 15 in FIG. 7 is used in FIG. 3. A cylindrical gear wheel casing 48 is mounted on the support 35, in which a further gear wheel 49 is rotateably arranged and supported. In the wall of the gear wheel casing 48, two slots 48.1 are formed which are distant to each other and through which the chain 41 passes.

The chain 41 extends starting from the chain mount 47 on the chain support 42 towards the gear wheel casing 48 that is connected to the support 35. The chain 41 is put around the gear wheel 49 and extends through one of the slots 48.1 into the gear wheel casing 48 and through the other of the slots 48.1 to the outside of the gear wheel casing 48 and, therefore, it is redirected or deflected by 180° by the gear wheel 49. The chain 41 extends from the gear wheel casing 48 towards the chain support 42 and it entries into the compartment 44, it passes the gear wheel 45 that engages in the chain members of the chain 41, and it exits the compartment 44 after being deflected by 90°. After the compartment 44, the chain extends to the associated pedal or pedal lever, on which the chain is mounted by, for instance, a clamp or a bracket with its final chain member.

If the pressure cylinder 31 is subjected to pressure force against the force of the spring 36, the cylinder 37 is moved towards the actuator support 39. Along the cylinder 37, then also the support 35 with the gear wheel casing 48 is moved, whereby the chain 41 is pulled from the chain support 42 towards the actuator support 39. This movement is transferred from the gear wheel 49 to the mount of the chain 41 on the pedal, whereby the pedal is operated by the tension or pull of the chain.

If the pressure within the pressure cylinder 31 is decreased, the cylinder 37 along with the support 35 and the gear wheel casing 48 are shifted or moved back by the spring 36 towards the chain support 42, whereby the length of the chain between the chain support 42 and the gear wheel 49 or the gear wheel casing 48 is shortened and, thus, the operation of the coupled pedals is taken back.

A stroke of the pressure cylinder 31 or a stroke of the cylinder 37 in the actuator casing 34 and of the support 35 having the chain casing 48 is converted into a double as big stroke of the portion of the chain 41 between the chain support 42 and the pedal by the 180° redirection of the chain 41 via the gear wheel 49, whereby big strokes of the pedal can be performed by the actuator 30.

In FIG. 1, a pedal unit 80 that is arranged on the passenger's side is shown in accordance to a preferred embodiment of the present invention. The pedal unit 80 comprises to hydraulic cylinders 69, 68, which have identical construction and are arranged with distance to each other and in parallel to each other, pressure piston rods 70 and 71 of identical configuration, guiding rods 66 and 65 of identical configuration, a hydraulic block 64, a slider 63 or a carriage, which is supported on the guiding rods 66 and 65 moveably to and fro, which is clearly shown in FIG. 1 by the double arrow being shown, an end block 62, in which the pedal lever 60 is supported pivotably and jointly or articulately, and a supporting lever 61, which is jointly supported on the pedal lever 60 and also on the slider 63 and which, therefore, couples the slider 63 to the pedal lever 60 in order to transfer a movement of a pedal lever 60 to the slider 63 by means of the supporting lever 61.

The pedal lever 60 engages in a recess of the end block 62 with one of its ends, in which a pin extends, around the longitudinal axis thereof the pedal lever 60 can be pivoted or rotated. The recess in the end block 62 has dimensions such that a sufficient freedom of movement of the end of the pedal lever 60, which is supported in the end block 62, is provided. A plane pedal disc is fixed to an opposite end of the pedal lever 60 that allows an operation by foot by the passenger or the driving school instructor.

The supporting lever 61 is jointly mounted on the pedal lever 60 so that a movement of the pedal lever 60 is transferred to the supporting lever 61. The other end of the supporting lever 61 engages in a slotted recess 63.1 (refer to FIG. 5) of the slider 63 and it is supported within this recess rotateably or pivotably around a transverse pin wherein the transverse pin of the slider 63 is oriented for supporting the supporting lever 61 in parallel to the supporting pin in the end block 62 for supporting the pedal lever 60. Further, the transverse pin for supporting the supporting lever 61 in the slider 63 and also the supporting pin for supporting the pedal lever 60 in the end block 62 are oriented perpendicularly to a direction of movement of the slider 63 on the guiding rods 65 and 66.

The block shaped slider 63 is moveably supported or mounted with a linear support 72 on the guiding rod 66 and with a second linear support 74 on the guiding rod 65. Both linear supports 72 and 74 or bearings are fitted or inserted in bores, holes or channels passing through and having a section of circular shape in the slider 63, and are accommodated therein and allow a linear support of the slider 63 on the guiding rods 66 and 65. The slider 63 consists of, for instance, polyethylene (type Simona PE-HWST according to ISO 10285). As linear support 72 or 74, for instance, a linear ball bearing having running path plates (type SKF LBBR12-2LS) can be used.

Further, in the slider 63, pressure piston rods 70 and 71, which extend in parallel to each other, are fixed with their ends being not adjacent to the pressure piston. Thus, a movement or shifting of the slider 63 on the guiding rods 66 and 65 is transferred directly onto the pressure piston rods 70 and 71.

The pressure piston rods 70 and 71 engage in the pressure cylinder 69 and 68 with the pressure piston rod 70 projecting into the pressure cylinder 69 and the pressure piston rod 71 projecting into the pressure cylinder 68. Pressure pistons are arranged on the ends of the pressure piston rods 70 and 71 which are located within the pressure cylinders 69 and 68, wherein the pressure pistons are moveably and sealingly supported in the corresponding pressure cylinders 69 and 68, respectively. A movement of the pressure piston rods 70 or 71 is transferred to the corresponding pressure pistons and, therefore, it acts on the liquid column within the pressure cylinders.

Both pressure cylinders 69 and 68 extend in parallel to each other and are fixed in the hydraulic block 64, for instance, by corresponding screw connections. The exits of both pressure cylinders 68 and 69 are united via a channel 64.1 in the hydraulic block 64 to an entrance of the hydraulic block 64 that is provided with a hollow screw 64.2 (refer to FIG. 5).

The guiding rods 66 and 65 extending in parallel to each other are fixedly connected at one end to the hydraulic block 64, for instance, by means of corresponding screw connections. They extend further through the slider 63, namely through the linear supports 72 and 74, and to the end block 62 to which they are connected again, for instance by screw connections. A compression spring 68 is installed between the slider 63 and the hydraulic block 64, the compression spring is wound around the guiding rod 66 in the shape of a helix. The compression spring 68 or helical spring is fixed or screwed with one end to the hydraulic block 64, whereas the other end of the compression spring 68 is screwed on the slider. The compression force of the compression spring 68 moves the slider 63 away from the hydraulic block 64 towards the end block 62 if there is not any counter force by the pedal lever 60. A further compression spring 67 or a coil spring is arranged on the guiding rod 65 between the slider 63 and the hydraulic block 64 and is fixed thereon like the compression spring 68. The compression force of the compression spring 67 also tends to move the slider 63 away from the hydraulic block 64 towards the end block 62.

A sleeve 73 is pushed onto the guiding rod 66 between the slider 63 and the end block 62. An identical sleeve 73 is also pushed onto the guiding rod 65 between the slider 63 and the end block 62. Both sleeves 73 are configured identically to each other and have the purpose to limit the movement of the slider 63 towards the end block 62. I.e. the slider 63 touches the sleeves 73, if only the compression forces of both springs 68 and 67 act without any counter force of a pedal operation. The slider 63 then is in the position shown in FIG. 1.

The fictitious symmetry axis F of the pressure cylinder 69 and the fictitious symmetry axis of the pressure piston rod 70 coincide. In addition, the fictitious axes of the pressure cylinder and of the pressure rod 71 coincide. The axes of both pressure cylinders 69 and 68 are oriented accurately in parallel to each other. Additionally, the axes of the guiding rods 66 and 65 are oriented in parallel to each other and extend along with the axes of the pressure cylinders 69 and 68 in a common plane. The supporting lever 61 is supported in the middle of the slider 63 so that forces occurring during operation of pedal are evenly distributed to both cylindrical pistons 70 and 71 via the slider 63. In addition, the pedal lever 60 is supported in the middle between the guiding rods 66 and 65 on the end block 62.

The pedal unit is preferably mounted on a plate 100 or basis, which lies on the passenger's side base of the vehicle and is fixed thereon preferably by a Velcro fastener. Thus, the pedal unit 80, due to the circumstances that only a Velcro fastener is required, can easily be mounted and, if necessary, demounted, too. The pedal unit 80 or its mounting plate 100 may also be screwed on the base. The Velcro fastener is sufficient since the force acting during operation of pedal on the pedal lever 60 is transferred via the pedal lever 60 and the supporting lever 61 to the slider 63 so that only a linear force component is developed only in the direction of movement of the slider 63 and additionally a force component is developed which acts perpendicularly to the direction of movement of the slider 63, i.e. towards the base of the vehicle, whereby the pedal unit 80 is pressed perpendicularly towards the base of the vehicle during operation of pedal and, therefore, tilting forces can not act on the pedal unit 80 during operation of pedal.

In FIGS. 4 and 5, a preferred embodiment of double pedal device of the invention for a driving school vehicle is shown as an example, wherein in FIG. 4 the pedal set or the pedal means 90.5 on the driver's side of the vehicle and in FIG. 5 the second pedal set or the second pedal means 80.5 on the passenger's side are shown, i.e. on the instructor's side.

The first pedal set 90.5 on the driver's side comprises as usually an accelerator pedal 95, a brake pedal 94 and a clutch pedal 93, an actuator 10 according to FIG. 2, the catch 15 thereof is engaged in a pedal lever 93.1 of the pedal 93, an additional actuator 30 which is shown if FIG. 3 in more detail, a chain 41 thereof is on one of it ends fixed to a pedal lever 94.1 of the pedal 94, for instance, using a clamp or a bracket, and an additional actuator 10.1 having the same configuration as the actuator 10 in FIG. 2 and having a catch 15.1 which is engaged in a pedal lever 95.1 of the pedal 95. An actuator plate 96 is provided on which the actuator 10 together with the actuator support 19 is mounted, on which the actuator 30 together with its support 39 is fixed and on which in addition the actuator 10.1 together with its actuator support is fixed.

The pressure cylinder 11 of the actuator 10 is fluid coupled via the hollow screw 13 terminating the pressure cylinder 11 to the hydraulic pressure line 92. The pressure cylinder 31 of the actuator 30 is fluid coupled via the hollow screw 33 to a pressure line 91. The pressure cylinder 11.1 of the actuator 10.1 is fluid coupled to a pressure line 90, too.

The second pedal set 80.5 on the passenger's side has a casing that is not shown and, according to FIG. 5, three pedals 97, 98, 99, wherein the pedal 97 is the accelerator pedal, the pedal 98 is the brake pedal, and the pedal 99 is the clutch pedal. The second pedal set comprises a pedal unit 80 that is described in more detail in FIG. 1, a further pedal unit 80.1 that corresponds to the pedal unit 80 being described in FIG. 1, and a third pedal unit 81 that, in difference to the pedal units 80 and 80.1, only comprises a single pressure cylinder having a pressure piston rod, a single guiding rod with compression spring, a slider correspondingly designed, a hydraulic block and a supporting lever connection to the pedal 97.

The hydraulic block 64 of the pedal unit 80 is interconnected to the pressure line 92 via the hollow screw 64.2 that has a screwing bolt. The hydraulic block of the pedal unit 80.1 is coupled to the pressure line 91 via a hollow screw. The hydraulic block of the pedal unit 81 is also coupled to the pressure line 90 via hollow screw.

The used hydraulic means comprise, as shown in FIG. 5, the pressure cylinder means on the passenger's side each having a pressure cylinder with pressure piston rod, the pressure cylinder means of the actuators 10, 10.1 and 30 each having a pressure cylinder and an associated pressure piston rod, the flexible pressure lines 90, 91 and 92, and the hydraulic blocks 64 on the passenger's side are filled with a hydraulic liquid. A hydraulic oil, gabel or fork oil, or white oil can be used as hydraulic liquid. Preferably, a hydraulic liquid having a viscosity number 1 is used in order to avoid delays in reaction of the hydraulic liquid column on fluctuations of the pressure. A white oil preferably used is a Renolin MRLVG5 type oil and has a viscosity number of 1. The pressure lines are, for instance, micro fluid flexible hose lines made of synthetic armid fibers (e.g. type EMMKT8 PN500 PB 800 DN 2).

In operating the pedal 99 on the instructor's side the slider 63 is shifted towards the hydraulic block 64 whereby the piston rods 70 and 71 exert pressure on the liquid column in the pressure cylinders 69 and 68. This pressure is transferred within the liquid column from the hydraulic block 64 to the pressure line 92 and, finally, the pressure is coupled to the pressure cylinder 11 of the actuator 10 via the hollow screw 13. The pressure piston rod 18 then shifts the cylinder 17 together with the catch 15. Since the catch 15 is engaged in the pedal lever 93.1 of the pedal 93, the pedal 93 is operated. If the pressure on the pedal 99 is decreased or removed, the spring 16 of the actuator 10 shifts back the cylinder having the catch 15 and, thus, also the pressure piston rod 18. The slider 63 of the pedal unit 80 is shifted back in its initial position, i.e. the stop position at the sleeves 73, by the spring force of both springs 67 and 68 and by the change or the suction pressure in the pressure cylinders.

If the pedal 98 is operated on the passenger's side, the pressure on the liquid column is transferred via both pressure cylinders and the hydraulic block of the pedal unit 80.1, having the same construction as the pedal unit 80, to the pressure line 91 and therefrom to the pressure cylinder 31 of the actuator 30. Thus, the support 35 having the gear wheel casing 48 is shifted whereby the portion of the chain between the chain support 42 and the pedal lever 94.1 is shortened and the pedal 94 is operated. If thereafter the operation of the pedal 98 on the passenger's side is decreased or removed, the pedal 94 is shifted back into its resting position by its pedal reshifting spring (not shown) whereby tension is exerted on the chain 41 being connected to the pedal lever 94.1 of the pedal 94, and thereby the support 35 together with the gear wheel casing 48 is now drawn back towards the chain support 42. The pressure on the liquid column is directed back to the passenger's side, namely to the hydraulic block of the pedal unit 80.1, via the pressure cylinder of the actuator 30 and the pressure line 91, thereby the pressure cylinder of the pedal unit 80.1 together with the compression springs of the pedal unit 80.1 shift back the slider in its initial position. Similar processes also occur in operating the pedal 97 via the pedal unit 81, the pressure line 90, and actuator 10.1 that is coupled to the pedal lever 95.1.

In the following, a further preferred embodiment of the double pedal device of the invention for a driving school vehicle with automatic transmission is explained using FIGS. 6, 7, 8, 9, and 10.

In FIG. 7, an actuator 10.2 which is used in the same construction as an anti gas or anti accelerator actuator 10.12 and also as an accelerator or gas actuator 10.22 of actuator means 10.32 of a driver's side accelerator pedal hydraulic means (refer also to FIG. 9) is shown in a separated perspective and partly sectional view. The actuator 10.2 comprises a cylindrical hollow actuator casing 14.2 that is opened at the ends, a pressure cylinder 11.2 that extends at least in part in the hollow space of the actuator casing concentrically with the axis of the actuator casing, a piston rod 18.2 or piston bar that is coupled by pressure to the pressure cylinder 11.2 within the actuator casing 14.2 via a pressure cylinder piston not shown and that is fixedly coupled to a catch cylinder 17.2 on its other end, which shiftably fits into the cavity of the actuator casing 14.2 and can be moved to and fro therein along the axis of the actuator casing 14.2., and a spring 16.2 that extends concentrically with the axis of the actuator casing 14.2 between the other end of the actuator casing 14.2, i.e. in more detail between the catch cylinder 17.2 and an actuator support 19.2 made of synthetic resin which terminates the other end of the actuator casing 14.2.

The pressure cylinder 11.2 consists of a stainless steel or aluminium and is hydraulically coupled to an associated pressure line of the hydraulic coupling means via a hollow screw 13.2 being mounted to pressure cylinder 11.2 at the end and having, on one of its ends, a thread socket for screwing in. The pressure cylinder 11.2 is arranged concentrically with the axis of the actuator casing 14.2 in the cavity of the actuator casing 14.2. On the end region towards the hollow screw 13.2, the pressure cylinder 11.2 has grooves 12.2 extending radially and annularly on its outer surface in which pins 20.2 passing through corresponding holes in the wall of the actuator casing 14.2 are engaged in order to fix the pressure cylinder 11.2 on the actuator casing 14.2.

In FIG. 7 the pressure cylinder 11.2 comprises five of these grooves 12.2 wherein two grooves being next to each other can not been seen in FIG. 7 since they are covered by the wall of the actuator casing 14.2, but they are engaged in associated fixing pins 20.2 both being shown.

On establishing or adjusting of the actuator 10.2, it can be determined by the radial grooves 12.2 and the pins 20.2 cooperating therewith how far the pressure cylinder 11.2 extends into the actuator casing 14.2 or how far it projects there from at its end, whereby the position of the catch 15.2 along the actuator casing 14.2 in its initial position can be adjusted in which there is not any pressure acting on the pressure cylinder 11.2, and therefore also the maximum stroke of the catch 15.2 of the actuator 10.2 can be adjusted for adapting to the respective construction of the associated pedal. The actuator 10.2 can therefore be adapted to the pedals of different types of vehicles having different stroke of pedal.

A pressure piston not shown is located within the pressure cylinder 11.2 on which the hydraulic pressure acts, which is present in the pressure cylinder. The pressure piston is supported within the pressure cylinder 11.2 in a sealing and moveable manner such that hydraulic liquid cannot escape out of the pressure cylinder 11.2. The pressure piston is connected to a piston rod 18.2 in the pressure cylinder 11.2 which projects from the pressure cylinder 11.2 in the interior of the actuator casing 14.2 and which extends concentrically to the axis of the cylindrical actuator casing 14.2.

A catch cylinder 17.2 is accommodated at the other end of the piston rod 18.2 or the piston bar which can be moved to and fro in the interior of the actuator casing 14.2 along the axis of the actuator casing 14.2 and which moves depending on the pressure acting on the hydraulic pressure cylinder 11.2. The catch cylinder 17.2 can be made of stainless steel, aluminium, or synthetic resin and is preferably designed in a solid manner.

The catch 15.2 is fixed on the outer surface of the catch cylinder 17.2 and comprises a hooked shape in the elevation view wherein the opening or aperture of the hooked catch 15.2 faces to the end of the actuator casing 14.2 having the actuator support 19.2. The catch 15.2 comprises a catch leg extending in parallel to the axis of the actuator casing 14.2, and a catch basis being attached to the catch cylinder 17.2. The catch can be provided with synthetic resin, particularly Nylon, on its surface.

The opening of the catch that is the region between the outer wall of the actuator casing 14.2 and the face of the catch 15.2, being adjacent to the opening of the catch, is constructed such the pedal lever, to which the actuator 10.2 is coupled, is fitted in the opening of the catch 15.2 in order to ensure a secure operation of the associated pedal or pedal lever.

A spring 16.2 being constructed as a compression spring is accommodated in the cavity of the actuator casing 14.2 between the actuator support 19.2 and the catch cylinder 17.2, which pushes the moveable catch cylinder 17.2 towards the pressure cylinder 11.2 within the actuator casing 14.2.

The actuator support 19.2 is fitted in the cavity of the actuator casing 14.2 on the corresponding end thereof and it closes or terminates also the corresponding end of the actuator casing 14.2. The actuator support 19.2 serves as a stop of the spring 16.2 and for mounting the actuator 10.2 on the chassis of the vehicle on the driver's side within the region of the pedal or on a basic plate being separately provided and being installed or accommodated in the region or area of the pedal of the vehicle on the driver's side. The actuator support 19.2 can also be constructed as a joint or articulate in order to jointly attach the actuator 10.2 on the chassis of the basis plate in the area of the pedal of the driver's side.

A slot 21.2 is recessed in the wall of the actuator casing 14.2, which extends in parallel and along the axis of the actuator casing 14.2 and through which the catch 15.2 is projected out of the actuator casing 14.2 from the catch cylinder 17.2. The free width of the slot 21.2 or of the recess corresponds to the thickness or dimension of the catch 15.2 such that the catch 15.2 is able to move freely to and fro in the slot 21.2. The length of the slot 21.2 corresponds at least to the stroke of the catch 15.2, which is allowed in maximum. The slot 21.2 can be formed with regard to its dimensions such that the walls of the slot perform a guiding of the catch 15.2.

If the pressure cylinder 11.2 of the actuator 10.2 is subjected to pressure by operation of the associated pedal on the passenger's side which means by the driving instructor, the piston rod 18.2 and thus also the catch cylinder 17.2 and the catch 15.2 are shifted towards the actuator support 19.2 against the pressure force of the spring 16.2 whereby the pedal being engaged, e.g. the driver's side accelerator pedal, is operated on the driver's side. If then the operation of the pedal is decreased on the passenger's side, also the hydraulic pressure decreases in the pressure cylinder 11.2 and the catch cylinder 17.2 together with the catch 15.2 are moved by the spring 16.2 in the opposite direction, i.e. towards the pressure cylinder 11.2, until a balance between the pressure force of the pressure cylinder 11.2 and the pressure force of the spring 16.2 is present.

If the instructor decreases the pressure or force on the pedal or the pedal operation yet further until a pedal operation on the passenger's side is not present any more, the spring 16.2 pushes or shifts the catch cylinder 17.2 together with the catch 15.2 further and further towards the pressure cylinder 11.2 until the catch 15.2 reaches its initial position in which pressure does not act anymore by the pressure cylinder 11.2 but only pressure caused by the spring 16.2 is effective.

In FIG. 8 an actuator 30.2 is shown in a view corresponding to FIG. 7. The actuator 30.2 comprises an actuator casing 34.2 having a pressure cylinder 31.2 with grooves 32.2 extending radially on the surface and a terminating hollow screw 33.2, a catch 35.2 or support that projects out of the actuator casing 34.2, a spring 36.2 being constructed as a compression spring, and a moveable cylinder 37.2 in the interior of the actuator casing 34.2 which is connected to a piston rod 38.2 on one end which extends into the pressure cylinder 31.2 and which is connected to a pressure piston in the interior of the pressure cylinder 31.2. The pressure cylinder 31.2 in turn can be adjusted and mounted by the grooves 32.2 and the fixing pins 40.2 on the actuator casing 34.2.

The construction and function of the members 31.2, 32.2, 33.2, 34.2, 36.2, 39.2 and 51.2 are identical to the instruction and function of the corresponding members of the actuator 10.2 being shown in FIG. 7. Concerning a more detailed description of the construction and function of this members or parts thus it is referred to a description mentioned above with regard to FIG. 7.

In contrast to the actuator 10.2 in FIG. 7, however, the actuator 30.2 in FIG. 8 does not have any catch, but it is coupled via a chain 41.2 to an associated pedal lever or driver's side pedal, e.g. the driver's side brake pedal. The construction of the actuator 30.2 having the chain 41.2 is described in detail in the following.

A chain support 42.2 is set on or pushed on the cylindrical actuator casing 34.2 of the actuator 30.2, which is formed as a cuboid block. The chain support 42.2 is clamped on the actuator casing 34.2 of the actuator 30.2 by means of a clamping or fixing screw 43.2. In FIG. 8 a small gap 52.2 in the lower area of the chain support 52.2 can be seen which allows a clamping by the clamping screw 43.2 on the surface of the actuator casing 34.2. Before clamping of the chain support 42.2, the chain support 42.2 can be shifted on the periphery or circumference of the cylindrical actuator casing 34.2 and therefore its final position can be adjusted. By clamping, the chain support 42.2 is fixed on the actuator casing 34.2 in its position along the actuator casing 34.2. In the upper portion of the block shaped or cuboid chain support 42.2, a compartment 44.2 is provided which is opened via the shown corner of the chain support 42.2 to the outside or accessible from the outside. A first gear wheel 45.2 or pinion is located around a shaft 46.2 or rotateably there with. The chain 41.2 is held with one of its ends on the chain support 42.2 by means of a chain fastening 47.2.

A support 35.2 is connected to the cylinder 37.2, which projects out of the actuator casing 34.2 through a slot 51.2. The hooked catch 15.2 of FIG. 7 is used as support 35.2 in FIG. 8. A cylindrical gear wheel casing 48.2 is fixed on the support 35.2, in which a further gear wheel 49.2 is rotateably arranged or supported. In the wall of the gear wheel casing 48.2, two slots 48.12 are recessed in distance to each other, through which the chain 41.2 extends.

The chain 41.2 extends from the chain fastening 47.2 on the chain support 42.2 towards the gear wheel casing 48.2 that is coupled to the support member 35.2. The chain 41.2 is put around the gear wheel 49.2 and it extends through one of the slots 48.12 again out of the gear wheel casing 48.2 and, thus, it is deflected by 180° by the gear wheel 49.2. The chain 41.2 extends from the gear wheel casing 48.2 towards the chain support 42.2 and enters the compartment 44.2, passes the gear wheel 45.2, which engages in the elements of the chain 41.2, and leaves again the compartment 44.2 after being redirected or deflected by 90°. The chain extends from the compartment 44.2 to the associated pedal or pedal lever on which the chain is fixed with its end member, e.g. by means of a clamp or bracket.

If the pressure cylinder 31.2 is loaded by pressure against the force of the spring 36.2, the cylinder 37.2 is moved towards the actuator support 39.2. The support 35.2 with the gear wheel casing 48.2 moves together with the cylinder 37.2 whereby the chain 41.2 is pulled from the chain support 42.2 towards the actuator support 39.2. This movement is transferred via the gear wheel 49.2 to the fastening of the chain 41.2 on the pedal whereby the pedal is operated by the tension of the chain.

If the pressure in the pressure cylinder decreases, the cylinder 37.2, the support 35.2, and the gear wheel casing 48.2 are shifted back towards the chain support 42.2 by the spring 36.2, whereby the length of the chain between the chain support 42.2 and the gear wheel 49.2 or the gear wheel casing 48.2 is shortened and, therefore, the operation of the coupled pedal is lowered.

A stroke of the pressure cylinder 31.2 or the stroke of the cylinder 37.2 in the actuator casing 34.2 and the support 35.2 with the gear wheel casing 48.2 is converted into a twice as big stroke of the chain part of the chain 41.2 between the chain support 42.2 and the pedal whereby big strokes or movements of the pedal can be performed by the actuator 30.2.

In FIG. 6 a pedal unit 80.2 according to a preferred embodiment of the invention and being arranged on the passenger's side is shown.

The pedal unit 80.2 has an anti gas or anti accelerator pedal 99.2 and anti accelerator pedal hydraulic means having two hydraulic cylinders 69.2, 68.2 arranged in parallel and apart to each other as pressure cylinder means having the same construction, compression springs 68.2 and 67.2 having the same construction, guiding rods 66.2 and 65.2 having the same construction, a hydraulic block 64.2, a slider 63.2 or carriage being supported on the guiding rods 66.2 and 65.2 such that it can move to and fro which is explained by the double arrow shown in FIG. 6, an end block 62.2 in which a pedal lever 60.2 is supported jointly in a pivotal manner, and a support lever 61.2 being supported jointly on the pedal lever 60.2 and on the slider 63.2 and, thus, coupling the slider 63.2 to the pedal lever 60.2 in order to transfer a movement of the pedal lever 60.2 to the slider 63.2 via the support lever 61.2.

The pedal lever 60.2 engages with one end in a recess of the end block 62.2 in which a pin extends, the pedal lever 60.2 being pivotably or rotateably around a longitudinal axis of the pin. The recess in the end block 62.2 is formed in dimensions such that a sufficient freedom of movement of the end of the pedal lever 60.2 being supported in the end block 62.2 is provided. A pedal disc of the anti gas pedal 99.2 is attached to the opposite end of the pedal lever 60.2 which allows to be operated by the passenger's or instructor's foot.

The support lever 61.2 is mounted on the pedal lever 60.2 jointly such that a movement of the pedal lever 60.2 is converted into a movement of the support lever 61.2. The other end of the support lever 61.2 engages in a recess 63.12 having the form of a slot in the slider 63.2 and it is supported rotaetably or pivotably again around a transverse pin wherein the transverse pin of the slider 63.2 is oriented for supporting or mounting the support lever 61.2 in parallel to the support pin in the end block 62.2 for supporting the pedal lever 60.2. Further, the transverse pin for supporting the support lever 61.2 in the slider 63.2 and also the mounting pin for supporting the pedal lever 60.2 in the end block 62.2 are oriented perpendicularly to a direction of movement of the slider 63.2 on the guiding rods 66.2 and 67.2.

The rectangular slider 63.2 is supported by a linear bearing 72.2 on the guiding rod 66.2 and it is supported by a second linear bearing 74.2 on the guiding rod 65.2. Both linear bearings 72.2 and 74.2 are fitted and accommodated in bores or channels extending through and having a circular section in the slider 63.2 and they allow a linear support of the slider 63.2 on the guiding rods 66.2 and 65.2. The slider 63.2 consists, for instance, of polyethylene (type Simona PE-HWST according to ISO 10285). For instance, a linear ball bearing having running surface plates (type SKF LBBR12-2LS) can be used as linear bearing 72.2 or 74.2.

Further, pressure piston rods 70.2 and 71.2 extending in parallel to each other are mounted with their ends being free from the pressure piston in the slider 63.2. A movement or a shifting of the slider 63.2 on the guiding rods 66.2 and 65.2 is thus directly transferred to the pressure piston rods 70.2 and 71.2.

The pressure piston rods 70.2 and 71.2 engage in the pressure cylinders 69.2 and 68.2 wherein the pressure piston rod 70.2 projects into the pressure cylinder 69.2 and wherein the pressure cylinder rod 71.2 projects into the pressure cylinder 68.2. Pressure pistons being supported moveably and sealingly within the corresponding pressure cylinders 69.2 and 68.2, respectively, are arranged on the ends of the pressure piston rods 70.2 and 71.2 that are located in the pressure cylinders 69.2 and 68.2. A movement of the pressure cylinder rods 70.2 or 71.2 acts on the respective pressure pistons and, therefore, it acts on the liquid column in the pressure cylinders.

Both pressure cylinders 69.2 and 68.2 extend in parallel to each other and they are fixed in the hydraulic block 64.2, for instance, by corresponding screwing means. The outlets of both pressure cylinders 68.2 and 69.2 are united to an inlet in the hydraulic block 64.2 by means of a channel 64.12 in the hydraulic block 64.2.

The guiding rods 66.2 and 65.2 extending in parallel to each other are fixedly connected to the hydraulic block 64.2 at one end, for instance, by suitable screwing means, extend further through the slider 63.2, namely through the linear bearings 72.2 and 74.2, respectively, and extend further to the end block 62.2 with which they are fixedly connected again, for instance, by screws. A compression spring 68.2 wounding around the guiding rod helically is mounted between the slider 63.2 and the hydraulic block 64.2. The compression spring or helical spring is fixed or screwed with one end on the hydraulic block 64.2 whereas the other end of the compression spring 68.2 is screwed on the slider. The compression force of the compression spring 86.2 shifts the slider 63.2 away from the hydraulic block 64.2 towards the end block 62.2 if a counter force of the pedal lever 60.2 does not exist. An additional compression spring 67.2 or helical spring is arranged on the guiding rod 65.2 between the slider 63.2 and the hydraulic block 64.2 and it is fixed thereto like the compression spring 68.2. In addition, the compression force of the compression spring 67.2 tends to shift the slider 63.2 away from the hydraulic block 64.2 towards the end block 62.2.

A stop sleeve 73.2 is shifted on the guiding rod 66.2 between the slider 63.2 and the end block 62.2. An identical stop sleeve 73.2 is shifted on the guiding rod 65.2 between the slider 63.2 and the end block 62.2. Both stop sleeves 73.2 are constructed identically to each other and have the purpose to limit the movement of the slider 63.2 towards the end block 62.2, which means, that the slider 63.2 is stopped at the stop sleeves 73.2 if only the compression forces of both springs 68.2 and 67.2 act without any counter or opposite force by operating the pedal. Then, the slider 63.2 is in the position shown in FIG. 6.

The fictitious symmetry axes of the pressure cylinder 69.2 and of the pressure piston rod 70.2 coincide. The fictitious axes of the pressure cylinder and of the pressure rod 71.2 coincide. The axes of both pressure cylinders 69.2 and 68.2 extending accurately in parallel to each other. Further, the axes of the guiding rods 66.2 and 65.2 are oriented in parallel to each other and are arranged together with the axes of the pressure cylinders 69.2 and 68.2 in a common plane. The support lever 61.2 is supported in the middle of the slider 63.2 such that the forces occurring during operation of pedal are distributed uniformly via the slider 63.2 onto both cylinder pistons 70.2 and 71.2. In addition, the pedal lever 60.2 is supported in the middle between the guiding rods 66.2 and 65.2 on the end block.

The pedal unit 80.2 is preferably attached to a plate 100.2 that is arranged on the base chassis on the passenger's side of the vehicle in the area of the passenger where it may be fixed to preferably by a Velcro fastener. Thus, the pedal unit 80.2 can easily be mounted and demounted since only the Velcro fastener has to be used. The pedal unit 80.2 or its mounting plate 100.2 can be secured by screws to the base. The Velcro fastener is sufficient as the force being present during pedal operation on the pedal lever 60.2 is transferred from the pedal lever 60.2 and the support lever 61.2 to the slider 63.2 such that a linear component of the force that arises in the moving direction of the slider 63.2 only, and a further component of force arises which acts perpendicularly to the moving direction of the slider 63.2, i.e. towards the base of the vehicle. Due to these components of force, the pedal unit 80.2 is pressed in normal direction onto the base of the vehicle if the pedal is operated, and, therefore, no tilting forces can act on the pedal unit 80.2 during operation of pedal.

Referring to FIG. 9 and FIG. 10, a preferred embodiment of the double pedal device of the invention to be used in a driving school vehicle and having automatic transmission, wherein FIG. 9 shows the set of pedals 90.6 on the driver's side of the vehicle and FIG. 10 shows the second pedal set 80.6 on the passenger's side, i.e. on the instructor's side.

The first pedal set on the driver's side comprises an accelerator pedal 95.2, a brake pedal 94.2, an anti accelerator actuator 10.12 being shown in FIG. 7 and having a catch 15.12 that is engaged in a pedal lever 95.12 of the accelerator pedal 95.2, a further actuator 30.2 being shown in more detail in FIG. 8 and having a chain 41.2, an end thereof is attached or secured to a pedal lever 94.12 of the pedal 94.2 by means of, for instance, a clamp, and an accelerator actuator 10.22 having the same construction as the anti accelerator actuator 10.12. A catch 15.22 of the accelerator actuator 10.22 is engaged in the pedal lever 95.12 of the accelerator pedal 95.2.

A pressure cylinder 11.12 of the anti accelerator actuator 10.12 is coupled to a hydraulic pressure line 92.2 for passage of liquid or fluid via a hollow screw 13.12 that covers the pressure cylinder 11.12. The pressure cylinder 31.2 of the actuator 30.2 is coupled to the pressure line 91.2 via the hollow screw 33.2. A pressure cylinder 11.22 of the gas actuator 10.22 is coupled to a pressure line 90.2 or hydraulic line to allow passing of fluid.

The accelerator actuator 10.22 effects an increase of gas or acceleration and the anti accelerator actuator 10.12 effects a decrease of gas or acceleration. The gas pedal 95.2 is allowed to move between zero gas position in which no acceleration is present, and a full gas position in which full acceleration is present. The anti accelerator actuator 10.12 actuates the accelerator pedal 95.2 in the direction from the full acceleration position to the zero acceleration position if the anti accelerator pedal 99.2 on the passenger's side is operated. The accelerator actuator 10.22 actuates the accelerator pedal on the driver's side in the direction from the zero gas position to the full gas position if the accelerator pedal 97.2 on the instructor's side is operated.

The second set of pedals 80.6 on the passenger's side has three pedals as shown in FIG. 10, the accelerator pedal 97.2, the brake pedal 98.2 and the anti accelerator pedal 99.2. The second pedal set comprises a pedal unit 80.2 having the anti gas pedal 99.2, which is shown in more detail in FIG. 6, a further pedal unit 80.12 having the brake pedal 98.2 which corresponds to the pedal unit 80.2 being shown in FIG. 6, and a third pedal unit 81.2 having the accelerator pedal 97.2 which in contrast to the pedal units 80.2 and 80.12 comprises only one pressure cylinder with pressure piston rod, one guiding rod having compression spring, a slider, a hydraulic block and terminating block correspondingly adapted and being coupled to the accelerator pedal 97.2 via the supporting lever. Instead of the pedal unit 80.2, one could also use an additional pedal unit 81.2 or vice versa, wherein however the amendment of the pedal function has to be taken into account.

The hydraulic block 64.2 of the pedal unit 80.2 is coupled for passage of a fluid via the hollow screw 64.22 that has a screwing bolt to the pressure line 92.2. The hydraulic block of the pedal unit 80.12 is coupled to the pressure line 91.2 via its hollow screw. The hydraulic block of the pedal unit 81.2 is coupled to the pressure line 90.2 via its hollow screw.

The hydraulic means used which correspond to the passenger's side pressure cylinder means shown in FIG. 10 and each having a pressure cylinder with pressure piston rod, the pressure cylinder means of the actuators 10.12, 10.22 and 30.2 shown in FIG. 9 and each having a pressure cylinder and a relating pressure piston rod, the flexible pressure lines 90.2, 91.2 and 92.2 of a pressure line means, and the hydraulic blocks 64.2 are filled with a hydraulic liquid. A hydraulic oil, a fork oil, or a white oil may be used as hydraulic fluid. Preferably, a hydraulic liquid having a viscosity number of 1 is used in order to avoid delays in the response of the liquid column on alteration in pressure. White oil being preferably used is type Renolin MR1VG5 and has a viscosity number of 1. The pressure lines are, for instance, micro fluid tube or hose lines made of synthetic armid fibres (for instance, type EMMKT8 PN500 PB 800 DN 2).

If the anti accelerator pedal 99.2 on the instructor's side is operated, the slider 63.2 of the pedal unit 80.2 is shifted towards the hydraulic block 64.2 wherein the piston rods 70.2 and 71.2 provide pressure onto the liquid column within the pressure cylinders 69.2 and 68.2. This pressure is transferred within the liquid column from the hydraulic block 64.2 to the pressure line 92.2 and, finally, it is coupled into the pressure cylinder 11.12 of the anti accelerator actuator 10.12 via the hollow screw 13.12. The corresponding pressure piston rod then moves the cylinder along with the catch 15.12. Since the catch 15.12 is engaged in the pedal lever 95.12 of the driver's side accelerator pedal 95.2 being operated, the accelerator pedal 95.2 is moved back to its zero gas position resulting in reducing of gas or acceleration. If the force or pressure onto the anti accelerator pedal 99.2 is reduced or cancelled, the spring 16.2 of the anti accelerator actuator 10.12 pushes back the cylinder and catch 15.12 and, thus, the pressure piston rod, too. The slider 63.2 of the pedal unit 80.2 is moved back to its initial position, i.e. the stop position at the sleeves 73.2, by the alteration of the pressure or by the intake pressure within the pressure cylinders.

If the brake pedal 98.2 on the passenger's side is operated, the pressure on the liquid column propagates through both of the pressure cylinders and the hydraulic block of the pedal unit 81.12 to the pressure lines 91.2 and therefrom to the pressure cylinder 31.2 of the actuator 30.2. Consequently, the support 35.2 together with the gear wheel casing 48.2 is offset whereby the chain portion between the chain support 42.2 and the pedal lever 94.12 is shortened and the pedal 94.2 is operated or moved. If afterwards the operation of the pedal 98.2 on the passenger's side is reduced or cancelled, the pedal 94.2 is brought back into its resting position by its pedal bring back spring (not shown) whereby tension acts on the chain 41.2 that is coupled to the pedal lever 94.12 of the brake pedal 94.2, and thus the support 35.2 together with the gear wheel casing 48.2 is now pulled back towards the chain support 42.2. The pressure arising in this situation on the liquid column is directed back to the passenger's side, i.e. to the hydraulic block of the pedal unit 80.12, via the pressure cylinder of the actuator 30.2 and the pressure line 91.2 whereby the pressure cylinders of the pedal unit 80.12 together with the compression springs of the pedal unit 80.12 bring the slider back to its initial position.

By operating the passenger's side accelerator pedal 97.2 on the instructor's side, the slider of the pedal unit 81.2 is pushed towards the corresponding hydraulic block wherein the piston rod of the single pressure cylinder means of the pedal unit 81.2 provides pressure on the corresponding pressure cylinder 81.22. This pressure is transferred within the liquid column from the hydraulic block 81.32 to the pressure line 90.2 and, finally, it is transferred via the hollow screw 13.22 to the pressure cylinder 11.22 of the accelerator actuator 10.22. The pressure piston cylinder of the accelerator actuator 10.22 then operates the cylinder with catch 15.22. Since the catch 15.22 is engaged in the pedal lever 95.12 of the driver's side pedal accelerator pedal 95.2, the accelerator pedal 95.2 is moved towards its full gas position under increasing gas. Then, if the pressure on the passenger's side accelerator pedal 97.2 is reduced or cancelled, the spring of the accelerator actuator 10.22 pushes back again the cylinder together with the catch 15.22 and, thus, also the pressure piston rod. The slider of the pedal unit 81.2, then, is moved back to its initial position by the force of the single spring of the pedal unit 81.2, but in addition by the alternation of pressure or the intake pressure in the corresponding pressure cylinders of the pedal unit 81.2.

Referring to the example of FIG. 11 and FIG. 12, a preferred embodiment of the driving school instructor's post of the invention to be used in a driving school vehicle is shown. The instructor's post comprises an instructor's seat 1.5, the instructor's side pedal means 80.5 shown in FIG. 5 or the instructor's side pedal means 80.6 shown in FIG. 10, and display means 15.5. An example of the instructor's post is installed in the cap or cell of the vehicle comprising an instrument panel 14.5 in a bus that is used as a driving school vehicle.

The instructor's seat 1.5 comprises a seat portion or member 31.5, a backrest member 2.5, a head support 6.5, a pneumatic spring 5.5 or air suspension, one end thereof is coupled to the seat portion 31.5 and the other end thereof is coupled to the driving school vehicle floor pan 3.5 or base. The backrest member 2.5 is pivotable around an axis 8.5 to adjust the inclination of the backrest member 2.5 in relation to the seat surface 7.5 of the seat portion 31.5 for sitting on. By operating a valve of the pneumatic spring 5.5 by means of a lever 32.5, the height of the level of the seat surface 7.5 above the floor pan 3.5 can be adjusted. The floor pan 3.5 is secured to a floor group 9.5 of the bus by screws 4.5. Using a screw connection allows a quick installation of the instructor's seat 1.5 and, thus, of the whole instructor's post in the bus, and, further, a quick and easy demounting of the seat which allows a quick conversion of the vehicle to a driving school vehicle and vice versa, too. As illustrated in FIG. 11, the seat surface 7.5 is present at a higher level of height than the seat surface of a driver's seat 11.5 in comparison to a dashed driver's seat 11.5 shown schematically.

The driving school instructor's seat 1.5 and/or instructor's post may be located in the middle between the driver's seat 11.5 and passenger's seat not shown wherein this middle area may also extend towards the rear of the vehicle as shown in FIG. 11.

The instructor's side pedal means 80.5 (or 80.6) are attached to the seat portion 31.5 of the instructor's seat 1.5 by means of a holding device 12.5 or support. The holding device 12.5 comprises a seat plate 30.5, an inclined member 33.5, and a plate 34.5 that is oriented in parallel to the floor pan 3.5 or floor chassis group 9.5 of the vehicle. The seat plate 30.5 of the holding device 12.5 is fixed to the seat portion 31.5 by screws. The inclined member 33.5 extending downwards in an inclined manner couples the seat plate 30.5 to the plate 34.5 integrally. At the longitudinal edges of the plate 34.5, two guiding means 17.5 and 18.5 extending in parallel to each other are attached which provide through receptacles in an area of the edge of the pedal means 80.5 (or 80.6) that can be inserted into the guiding means 17.5 and 18.5 in accordance to the direction of arrow 19.5. On their topsides, the guiding means 17.5 and 18.5 have respective bores 38.5 being in series or corresponding longitudinal holes which help that the instructor's side pedal means 80.5 (or 80.6) can be locked in or fixed to the guiding means using screws or clamping. By offsetting or shifting the pedal means 80.5 (or 80.6) within the guiding means 17.5 and 18.5, a distance A5 between the instructor's seat 1.5 and the pedal means 80.5 (or 80.6) can be adjusted.

On the plate 34.5 of the holding device 12.5, a display holder 16.5 is attached via an angle member, wherein display means 15.5 are attached to an end of the display holder. The display means 15.5 may be, for instance, a LCD or a monitor. The display means 15.5 is coupled electrically to a video camera 50.5 via coupling means and a connector 42.5 on the instrument panel 14.5. The video camera 50.5 is attached to a left exterior rear view mirror 40.5 of the bus and, thus, it detects the surrounding area on the left side of the bus. The image or picture detected by the video camera 50.5 is indicated to the driving school instructor on the display means 15.5 whereby, for instance, a vehicle in the “blind angle” can be recognized by the instructor.

The instructor's side pedal means 80.5 in FIG. 5 comprises the pedal units 80, 80.1, and 81 having the corresponding pedals 99, 98, and 97. The pedal means 80.5 are coupled to the supplementary driver's side pedal means 90.5 in FIG. 4 of the double pedal device for controlling the driver's pedal means 90.5 with priority via the pressure lines 90, 91, 92.

Similarly, the instructor's side pedal means 80.6 in FIG. 10 comprises the pedal units 80.2, 80.12, and 81.2 having the corresponding pedals 99.2, 98.2, and 97.2. The pedal means 80.6 are coupled to the supplementary driver's side pedal means 90.6 in FIG. 9 of the double pedal device having anti gas for controlling the driver's pedal means 90.6 with priority via the pressure lines 90.2, 91.2, 92.2.

FIGS. 13, 14 and 15 show another preferred embodiment of the instructor's post of the invention to be used in a driving school vehicle. The instructor's post comprises an instructor's seat 30.6, a controlling unit 20.6, instructor's side pedal means 80.5 on the passenger's side which is shown in FIG. 5 (or 80.6 in FIG. 10), and a holding device 1.6 or rack on which the pedal means 80.5 (or 80.6) are affixed. The instructor's post is installed, for instance, in the cap 40.6 or cell of the vehicle having an instrument panel 41.6 in a bus that is used as a driving school vehicle. The cap 40.6 of the vehicle has as usual a base 42.6 and a sheet like inner cover 43.6 extending normally to the base 42.6.

The instructor's seat 30.6 comprises, inter alia, a seat member 33.6 having a seat surface, a backrest member 31.6, and an armrest 32.6 on the right side and it is mounted on a base plate or base 42.6 of the driving school vehicle chassis. The instructor's seat 30.6 and/or the instructor's post can be located in a middle area between a driver's seat and a passenger's seat not shown.

The controlling unit 20.6 of the instructor's post of the invention is designed preferably in form of a control stick 20.16 or of a joystick and it has a handle 21.6, an angle member 24.6, a tubular fixing member 25.6, a control knob 22.6, and coupling means 23.6 for coupling of the control unit 20.6 to the electrical installations of the driving school vehicle.

The fixing member 25.6 is rigidly attached to the instructor's seat 30.6. The angle member 24.6 of the control unit 20.6 has a tubular member 24.16 extending horizontally and a further tubular member 24.26 extending vertically and normally to the tubular member 24.16. The tubular member 24.16 has a free end that is rotateably supported in the fixing member 25.6 around its axis and supported shiftably in and out of the fixing member 25.6. The tubular or cylindrical handle 21.6 of the control stick 20.16 is supported rotateably around its axis in the tubular member 24.26 at one end and it carries the control knob 22.6 at the other end. The control knob 22.6 provides a plurality of switches 26.6 or electrical operation units, e.g. controllers, which are provided for electrical switching of functions of the electrical devices in the driving school vehicle. The functions to be switched by the switches 26.6 are, for instance, the functions of the signalling devices, e.g. blinker and horn, the wipe and wash devices, e.g. the windscreen wiper, and of the headlight devices, e.g. the dimmed headlight and upper beam headlights of the driving school vehicle. The teacher or instructor may even control also driving functions like braking, operating the clutch, acceleration and even steering or operating gear box if the electrical devices of the driving school vehicle comprise corresponding electrical actuators and features, e.g. control of the accelerator operation, the clutch, the braking operation etc. driven by electric motor. The switches 26.6 and electrical actuator means of the control unit 20.6 are coupled via the coupling means 23.6 to the electrical devices of the driving school vehicle. For instance, a cable may be used as it is shown in FIG. 15 which extends in the interior of the tubular members 25.6, 24.16, 24.26, 21.6 to the control knob 22.6 and which is there connected to the switches 26.6, e.g. touch contact switches and rocker switches and actuators, either directly or via interface electronics. The cable is coupled, for instance, via a plug-type connection to a corresponding connector on the instrument panel 41.6 of the driving school vehicle. The connector of the instrument panel 41.6 or board is coupled electrically to the electrical devices of the driving school vehicle such that the function and features of the electrical system of the vehicle can be controlled by and from the control unit 20.6 as intended. But the coupling means 23.6 can be designed also as a telemetry arrangement comprising suitable transmitters and receivers for an electromagnetic, optical, e.g. infrared, or ultrasonic coupling of the control unit 20.6 to the electrical system of the driving school vehicle.

As generally preferred, the control unit 20.6 is attached to the instructor's seat 30.6 by, for instance, the mounting member 25.6. Further, the control unit 20.6 is arranged in the instructor's post so that the instructor can operate it in a comfortable and ergonomic manner. In the embodiment presently shown, the control stick 20.16 of the control unit 20.6 is located near the free end of the right armrest 32.6 of the instructor's seat so that the instructor can easily embrace the handle 21.6 of the control stick 20.16 by hand and, particularly, he can easily reach the switches 26.6 by thumb on putting his right forearm on the armrest. Thus, the handle 21.6 has an approximate length that approximately corresponds to the width of a hand. The switches 26.6 on the control knob 22.6 are then approximately one length of thumb in maximum distant from the end of the handle 21.6 to allow a safe and comfortable operation of the switches 26.6.

Display means (not shown) can be yet attached to the control unit 20.6. For instance, a LCD may be used as display means. The display means are preferably coupled to, for instance, a video camera by additional coupling means in an electrical manner. The video camera can be attached to the left exterior rear view mirror of the bus and, thus, it detects the surrounding area on the left side of the bus. The image or picture detected by the video camera is indicated to the instructor on the display means whereby, for instance, a vehicle in the “blind angle” can be recognized by the instructor. The display means can be attached to the topside of the control knob 22.6 of the control stick 20.16 in the control unit 20.6, for instance, by a flexible tube to adjust the position of the display means.

The pedal means on the instructor's side 80.5 (or 80.6) is attached to the vertical inner cover 43.6 or the vertical portion of the chassis of the driving school vehicle in the driver's cell 40.6.

The holding device 1.6 has substantially a frame having two vertical bars 6.6 and 6.16 or rods, a base plate 2.6, on which the vertical bars 6.6 and 6.16 stand perpendicularly, and an overhanging handle portion 12.6 projecting into the space of the driver's cell 40.6. The vertical bars 6.6 and 6.16 extend between the bottom plate 2.6 and the handle portion 12.6. Further, the holding device 1.6 has a footrest 7.6 and an attachment frame 10.6, 11.6 for attachment of the pedal means 80.5 (or 80.6) to the holding device 1.6.

The holding device 1.6 is connected to the base plate 2.6 on the base 42.6 of the driving school vehicle by screws. A transverse member 4.6 extends between the vertical bars 6.6 and 6.16 horizontally, the transverse member 4.6 is attached to the inner cover 43.6 of the driving school vehicle by screws.

The handle portion 12.6 has a transverse bar 3.6, a left side curved tube member 13.6 and a right side curved tube member 14.6 which connect the transverse bar 3.6 to the vertical bar 6.6 or the vertical bar 6.16 integrally. The curved tube members 13.6 and 14.6 project to the driver's side and passenger's door, respectively, in a curved and bellied manner oriented away from the vertical bars 6.6 and 6.16, respectively.

The footrest 7.6 has a rest tube 7.16 extending horizontally and perpendicularly to the vertical bars 6.6 and 6.16 of equal length in a transverse manner, and two support tubes 8.6 and 9.6 having equal length and extending in parallel to each other. The support tube 8.6 connects the rest tube 7.16 to the vertical bar integrally while the support tube 9.6 connects the rest tube 7.16 to the other vertical bar 6.6 integrally.

The attachment frame 10.6, 11.6 has two side members extending in parallel to each other, one on the side of the vertical bar 6.16 and the other (not shown) on the side of the vertical bar 6.6, the pedal means 80.5 (or 80.6) is attached, e.g. by screws, on and between them, and a transverse member 11.6 extending between the vertical bars 6.6 and 6.16 a little below the support tubes 8.6 and 9.6. The shown side member 10.6 is inclined relative to the plane of the vertical bars 6.6 and 6.16 towards the instructor's seat 30.6 and it includes an angle to the vertical bar 6.16 that, for instance, may be 15 °. Consequently, also the side member not being shown is inclined relative to the plane of the vertical bars 6.6 and 6.16 towards the instructor's seat 30.6 and it includes the same angle to the vertical bar 6.6 which, for instance, may also have 15°. The angle point is located on the bottom plate 2.6 while the opening of the angle is at the level of the transverse member 11.6 on which the side members 12.6 are welded.

As shown in FIG. 15 in which the pedals of the pedal means 80.5 are depicted in a non operated condition, the pedals are located, if the pedal means 80.5 (or 80.6) are attached or secured to the side members 10.6, in the space between the rest tube 7.16 of the footrest 7.6 and the base plate 2.6 of the holding device 1.6 or the base of the driver's cap or cell, or to say it in other words, the footrest 7.6 or its rest tube 7.16 is arranged in the space above the pedals. In more detail, the footrest and the transverse tube 7.16 extend in a plane being parallel to the plane of the vertical bars 6.6, 6.16, and a fictitious axis through the pedals 99, 98 and 97 extends in a plane being parallel to the vertical plane of the rest tube 7.16. The vertical plane of the rest tube 7.16 has a distance to the vertical parallel plane of the pedals. This horizontal distance is, for instance, 5 cm to 15 cm and it allows that the pedals can be reached without any obstacle. Thus, the footrest 7.6 extends in a displaced manner backwards within the area between the vertical bars 6.6, and 6.16 and this vertical plane of pedals. If one puts a horizontal plane through the pedals 99, 98, and 97 and a horizontal plane being parallel thereto through the rest tube 7.16, both planes are perpendicular to the vertical plane of the vertical bars 6.6 and 6.16, a vertical distance is present between both horizontal planes which may be, for instance, 5 cm to 20 cm. That means that the footrest 7.6 and the rest tube 7.16 are arranged in this distance in the area above the pedals.

It was found that the arrangement of the footrest 7.6 allows a very quick operation of the pedals by the instructor. The instructor, for instance, rests his left foot on the footrest 7.6. Then, if the instructor has to intervene in the present driving in order to correct the student driver, the foot only needs to be moved downwards onto the pedals, e.g. the pedal 99, to be able to provide a pedal operation. In this case, one can speak of “dropping” the foot that surprisingly leads to a very quick pedal operation reaction and, thus it leads to improved safety during driving school operation.

The instructor's side pedal means 80.5 of the instructor's post in FIGS. 13, 14 and 15 is shown in more detail in FIG. 5, which is composed of pedal units 80, 80.1 and 81 having the respective pedals 99, 98 and 97 for clutch, brake, and acceleration, respectively. The pedal means 80.5 is coupled to the supplementing driver's side pedal means 90.5 shown in FIG. 4 via the pressure lines 90, 91 and 92 for priority controlling of the driver's side pedal means 90.5.

The pedal lever 60 and the support lever 61 of the pedal linkage are surrounded by a flexible frill or cover 601 being closed and folded (see FIG. 15), which consists of rubber, e.g. india-rubber. The cover 601 protects the pedal means 80.5 against pollution or dirtying, e.g. splash water. The pedal lever and the support lever of the pedal 98 also are provided with a corresponding folded and flexible protective cover 602.

If the instructor's side pedal means 80.6 shown in FIG. 10 and having the pedal units 80.2, 80.12, and 81.2 and the corresponding pedals 99.2, 98.2, and 97.2 are used in the instructor's post according to FIGS. 13, 24, and 15, the pedal means 80.6 are coupled to the supplementary driver's side pedal means 90.6 of the double pedal means 90.6 having anti gas for priority controlling of the driver's side pedal means 90.6 via the pressure lines 90.2, 91.2, 92.2.

1. Double pedal device to be used in a driving school vehicle having at least one driver's side pedal (93, 94, 95), at least one instructor's or passenger's side pedal (99, 98, 97) and hydraulic means that couple the driver's side pedal to the passenger's side pedal so that the driver's side pedal is operated if the passenger's side pedal is operated, the hydraulic means comprise at least one driver's side pressure cylinder means (11, 18) being coupled to the driver's side pedal, at least one passenger's side pressure cylinder means (69, 70) being coupled to the passenger's side pedal and being symmetrical to an axis of symmetry (F), and at least one pressure line (92) that hydraulically couples the driver's side pressure cylinder means (11, 18) to the passenger's side pressure cylinder means (69, 70),
characterized by
a slider (63) that is mechanically coupled to the passenger's side pedal (99) and the passenger's side pressure cylinder means (69, 70) for transferring force between the passenger's side pedal (99) and the passenger's side pressure cylinder means (69, 70), and
guiding means (65, 66) on which the slider (63) is supported in a moveable manner.

2. Double pedal device according to claim 1, characterized in that the slider (63) is supported on the guiding means (65, 66) so that, on transferring force from the passenger's side pedal (99) to the passenger's side pressure cylinder means (69, 70), only a force or force components act on the pressure cylinder means (69, 70) in direction of the symmetry axis (F) of the pressure cylinder means (69, 70).

3. Double pedal device according to claim 1 or claim 2, characterized in that the guiding means comprise a guiding rod (66) on which the slider (63) is supported moveably or slidably.

4. Double pedal device according to claim 3, characterized in that the slider (63) is supported on the guiding rod (66) by means of a linear bearing or support.

5. Double pedal device according to claim 4, characterized in that an axis of symmetry of the guiding rod (66) is parallel to the axis of symmetry (F) of the passenger's side pressure cylinder means (69, 70) and that both axis of symmetry are in the same plane.

6. Double pedal device according to claim 3, characterized in that the guiding means have at least two guiding rods (65, 66) on which the slider (63) is supported, and that the guiding rods are arranged in parallel to each other and in distance to each other in the same plane.

7. Double pedal device according to claim 6, characterized in that at least two identical passenger's side pressure cylinder means (69, 70, 68, 71) are provided, the axes of symmetry thereof are arranged in parallel to each other and with distance to each other in the same plane.

8. Double pedal device according to claim 7, characterized in that the axes of symmetry of the guiding rods (65, 66) and the axes of symmetry of the passenger's side pressure cylinder means (69, 70; 68, 71) lie in parallel to each other and with distance to each other in the same plane.

9. Double pedal device according to claim 8, characterized in that a linear bearing (72) is provided for each guiding rod for supporting or bearing the slider (63).

10. Double pedal device according to one of the preceding claims, characterized in that the guiding means extends between a first block (64) and a second block (62), that the slider (63) is supported between the first block and the second block on the guiding means, that at least one spring (68) is provided between the first block and the slider (63) which pushes the slider (63) towards the second block (62), and that at least one passenger's side pressure cylinder means is arranged between the first block (64) and the slider (63).

11. Double pedal device according to claim 10, characterized in that a spacer is arranged between the slider (63) and the second block (62).

12. Double pedal device according to claim 10 or claim 11, characterized in that the second pedal (99) is supported in the second block (62) in a pivoted or hinged manner.

13. Double pedal device according to claim 12, characterized by a support lever (61), one end thereof is supported on the slider (63) in a hinged manner and the other end thereof is supported on a pedal lever (60) of the passenger's side pedal (99) in a hinged manner.

14. Double pedal device according to one of the preceding claims, characterized by at least one actuator (10, 30) on the driver's side of the vehicle which is engaged in the driver's side pedal wherein the actuator (10, 30) comprises the driver's side pressure cylinder means (11, 18).

15. Double pedal device according to claim 14, characterized in that the actuator (10) has a moveable catch means (15, 17) that is moved by the driver's side pressure cylinder means of the actuator (10) and that is engaged in the driver's side pedal.

16. Double pedal device according to claim 14 or claim 15, characterized in that the actuator (10, 30) has at least one spring (16), the force of the spring is opposed to the force of the pressure cylinder means of the actuator (10, 30).

17. Double pedal device according to claim 14, characterized in that the actuator comprises a gear, gearing or transmission that converts a movement of the pressure cylinder means (31) of the actuator (30) into a movement of the pedal (94) being engaged in the actuator (30) on the driver's side.

18. Double pedal device according to claim 17, characterized in that the gear, gearing or transmission has a chain (41) being attached to the pedal (94).

19. Double pedal device according to claim 18, characterized in that the gearing has a gear wheel (49) engaging in the chain (41) and deflecting the course of the chain by 1800.

20. Double pedal device according to claim 18 or claim 19, characterized in that the gearing has a further gear wheel (45) engaging in the chain (41) and deflecting the course of the chain (41) by 90°.

21. Double pedal device according to claim 20, characterized in that the gear wheel (49) is mechanically coupled to the pressure cylinder means of the actuator and is linearly moved by means of the pressure cylinder means.

22. Double pedal device according to claim 21, characterized in that the chain extends starting from a fixed attachment on a casing (34) via the gear wheel (49) being linearly moveable and the further gear wheel (45) being fixedly attached to the casing to the first pedal (94).

23. Double pedal device according to one of the preceding claims, characterized in that the hydraulic means has a hydraulic liquid having a viscosity number of 1.

24. Double pedal device according to one of the preceding claims, characterized in that the pressure line of the hydraulic means is flexible.

25. Double pedal device according to claim 24, characterized in that the pressure line is made of an armid synthetic fiber.

26. Double pedal device according to one of the preceding claims, characterized in that the slider (63) is made of polyethylene.

27. Pedal unit (80; 80.1; 81), particularly for use in a double pedal device for use in a driving school vehicle and particularly on the passenger's side of the driving school vehicle, having at least one pedal (99, 98, 97) and a hydraulic pressure cylinder means (11, 18) being mechanically coupled to the pedal and being symmetrical to an axis of symmetry (F),
characterized by
a slider (63) that is mechanically coupled to the pedal (99) and the pressure cylinder means (69, 70) for transferring force between the pedal (99) and the pressure cylinder means (69, 70), and
guiding means (65, 66) on which the slider (63) is supported in a moveable manner so that only a force or force components act on the pressure cylinder means (69, 70) in the direction of the axis of symmetry (F) of the pressure cylinder means (69, 70) during transferring of force from the pedal (99) to the pressure cylinder means (69, 70).

28. Pedal unit according to claim 27, characterized in that the guiding means comprise at least one guiding rod (66) on which the slider (63) is supported moveably or slideably.

29. Pedal unit according to claim 28, characterized in that the slider (63) is supported on the guiding rod (66) by means of a linear bearing (72) or support.

30. Pedal unit according to claim 29, characterized in that an axis of symmetry of the guiding rod (66) is parallel to the axis of symmetry (F) of the pressure cylinder means (69, 70) and that both axes of symmetry are in the same plane.

31. Pedal unit according to claim 28, characterized in that the guiding means have at least two guiding rods (65, 66) on which the slider (63) is supported, and that the guiding rods are arranged in parallel to each other and in distance to each other in the same plane.

32. Pedal unit according to claim 31, characterized in that at least two identical passenger's side pressure cylinder means (69, 70; 68, 71) are provided, the axes of symmetry thereof are arranged in parallel to each other and with distance to each other in the same plane.

33. Pedal unit according to claim 32, characterized in that the axes of symmetry of the guiding rods (65, 66) and the axes of symmetry of the passenger's side pressure cylinder means (69, 70; 68, 71) lie in parallel to each other and with distance to each other in the same plane.

34. Pedal unit according to claim 33, characterized in that one linear bearing (72) is provided for each guiding rod for supporting or bearing the slider (63).

35. Pedal unit according to one of the claims 27 to 34, characterized in that the guiding means extends between a first block (64) and a second block (62), that the slider (63) is supported between the first block and the second block on the guiding means, that at least one spring (68) is provided between the first block and the slider (63) which pushes the slider (63) towards the second block (62), and that at least one passenger's side pressure cylinder means is arranged between the first block (64) and the slider (63).

36. Pedal unit according to claim 35, characterized in that a spacer is arranged between the slider (63) and the second block (62).

37. Pedal unit according to claim 35 or claim 36, characterized in that the pedal (99) is supported in the second block (62) in a pivoted or hinged manner.

38. Pedal unit according to claim 37, characterized by a support lever (61), one end thereof is supported on the slider (63) in a hinged or jointed manner and the other end thereof is supported on a pedal lever (60) of the pedal (99) in a hinged or jointed manner wherein the angle between the support of the support lever on the slider (63), the support of the support lever on the pedal lever, and the support of the pedal lever on the second block (62) is an acute angle.

39. Pedal unit according one of the claims 27 to 38, characterized in that the slider (63) consists of polyethylene.

40. Actuator for engaging in a pedal on the driver's side of a driving school vehicle and particularly for use in a double pedal device of a driving school vehicle having hydraulic pressure cylinder means (11, 18), characterized in that the actuator (10) has moveable catch means (15, 17) that are driven by the pressure cylinder means of the actuator (10) and that are engaged in the pedal on driver's side.

41. Actuator according to claim 40, characterized in that the actuator (10) has at least one spring (16), the force of the spring is opposed to the force of the pressure cylinder means of the actuator (10, 30).

42. Actuator according to claim 40 or claim 41, characterized in that the catch means has a catch that is covered by nylon at least partly.

43. Actuator (30) for engaging in a pedal on the driver's side of a driving school vehicle having hydraulic pressure cylinder means (31), characterized in that the actuator (30) has a gear, gearing or transmission that converts a movement of the pressure cylinder means (31) of the actuator (30) to a movement of the pedal (94) engaging in the actuator (30).

44. Actuator according to claim 43, characterized in that the gear, gearing or transmission has a chain (41) being attached to the pedal (94).

45. Actuator according to claim 44, characterized in that the gearing has a gear wheel (49) engaging in the chain (41) and deflecting the course of the chain by 180°.

46. Actuator according to claim 44 or claim 45, characterized in that the gearing has a further gear wheel (45) engaging in the chain (41) and deflecting the course of the chain (41) by 90°.

47. Actuator according to claim 46, characterized in that the gear wheel (49) is mechanically coupled to the pressure cylinder means of the actuator and is linearly moved by means of the pressure cylinder means.

48. Actuator according to claim 47, characterized in that the chain extends starting from a fixed attachment on a casing (34) via the gear wheel (49) being linearly moveable and the further gear wheel (45), which is fixedly attached to the casing, to the first pedal (94).

49. Double pedal device, particularly for use in a driving school vehicle having automatic transmission, comprising a driver's side accelerator pedal (95.2), a passenger's side accelerator pedal (97.2), and coupling means that couple the driver's side accelerator pedal (95.2) to the passenger's side accelerator pedal (97.2) so that driver's side accelerator pedal (95.2) is also operated with increasing acceleration or gas if the passenger's side accelerator pedal (97.2) is operated, characterized by a passenger's side anti accelerator pedal (99.2), the coupling means coupling the driver's side accelerator pedal (95.2) to the passenger's side anti accelerator pedal (99.2) so that the driver's side accelerator pedal (95.2) is operated with decreasing acceleration or gas if the passenger's side anti accelerator pedal is operated.

50. Double pedal device according to claim 49, characterized in that the coupling means are hydraulic means having a driver's side accelerator pedal hydraulic means engaging in the driver's side accelerator pedal (95.2), a passenger's side accelerator pedal hydraulic means being coupled to the passenger's side accelerator pedal (97.2), a passenger's side anti accelerator pedal hydraulic means being coupled to the passenger's side anti accelerator pedal (99.2), and a pressure line means (90.2, 91.2, 92.2) that hydraulically connects the driver's side accelerator pedal hydraulic means to the passenger's side accelerator pedal hydraulic means and the passenger's side anti accelerator pedal hydraulic means

51. Double pedal device according to claim 50, characterized in that the driver's side accelerator pedal hydraulic means, the passenger's side accelerator pedal hydraulic means (69.2, 70.2) and the passenger's side anti accelerator pedal hydraulic means (69.2, 70.2) each comprise at least one pressure cylinder means (68.2, 69.2).

52. Double pedal device according to claim 51, characterized by a slider (63) being mechanically coupled to a passenger's side pedal (97.2, 98.2, 99.2) and to the corresponding pressure cylinder means (69.2, 70.2) in order to transfer force between the passenger's side pedal (99.2) and the pressure cylinder means (69.2, 70.2), and guiding means (65.2, 66.2) on which the slider (63.2) is supported moveably.

53. Double pedal device according to claim 52, characterized in that, on transferring force from the passenger's side pedal (97.2, 98.2, 99.2) to the pressure cylinder means (69.2, 70.2), only a force or force components in direction of the axis of symmetry (F) of the pressure cylinder means (69.2, 70.2) act on the pressure cylinder means (69.2, 70.2).

54. Double pedal device according to one of the claims 51 to 53, characterized by a slider (63) being mechanically coupled to the passenger's side anti accelerator pedal (99.2) and to the corresponding pressure cylinder means (69.2, 70.2) in order to transfer force between the passenger's side anti accelerator pedal (99.2) and the pressure cylinder means (69.2, 70.2), and guiding means (65.2, 66.2) on which the slider (63.2) is supported moveably.

55. Double pedal device according to claim 54, characterized in that, on transferring force from the passenger's side anti accelerator pedal (99.2) to the corresponding pressure cylinder means (69.2, 70.2), only a force or force components in direction of the axis of symmetry (F) of the pressure cylinder means (69.2, 70.2) act on the pressure cylinder means (69.2, 70.2).

56. Double pedal device according to one of the claims 53 to 55, characterized in that the guiding means comprise at least one guiding rod (66.2) on which the slider (63.2) is supported moveably or slidably.

57. Double pedal device according to claim 56, characterized in that the slider (63.2) is supported on the guiding rod (66.2) by means of a linear bearing (72.2) or support.

58. Double pedal device according to claim 57, characterized in that an axis of symmetry of the guiding rod (66.2) is parallel to the axis of symmetry (F) of the passenger's side pressure cylinder means (69.2, 70.2) and that both axis of symmetry are in the same plane.

59. Double pedal device according to claim 58, characterized in that the guiding means have at least two guiding rods (65.2, 66.2) on which the slider (63) is supported, and that the guiding rods are arranged in parallel to each other and in distance to each other in the same plane.

60. Double pedal device according to claim 51, characterized in that the passenger's side anti accelerator pedal hydraulic means has two pressure cylinder means (69.2, 70.2, 68.2; 71.2), the axes of symmetry thereof are arranged in parallel to each other and with distance to each other in the same plane.

61. Double pedal device according to claim 59 and claim 60, characterized in that the axes of symmetry of the guiding rods (65.2, 66.2) and the axes of symmetry of the pressure cylinder means (69.2, 70.2; 68.2, 71.2) of the anti accelerator pedal hydraulic means are parallel to each other and they lie with distance to each other in the same plane.

62. Double pedal device according to claim 61, characterized in that one linear bearing (72.2) is provided for each guiding rod for supporting or bearing the slider (63.2).

63. Double pedal device according to one of the claims 52 to 62, characterized in that the guiding means extend between a first block (64.2) and a second block (62.2), that the slider (63.2) is supported between the first block and the second block on the guiding means, that at least one spring (68.2) is provided between the first block and the slider (63.2) which pushes the slider (63.2) towards the second block (62.2), and that at least one passenger's side pressure cylinder means is arranged between the first block (64.2) and the slider (63.2).

64. Double pedal device according to claim 63, characterized in that a spacer is arranged between the slider (63.2) and the second block (62.2).

65. Double pedal device according to claim 63 or claim 64, characterized in that the anti accelerator pedal (99.2) or the passenger's side accelerator pedal are supported in the second block (62.2) in a pivoted or hinged manner.

66. Double pedal device according to claim 65, characterized by a support lever (61.2), one end thereof is supported on the slider (63.2) in a hinged manner and the other end thereof is supported on a pedal lever (60.2) of the passenger's side accelerator pedal (97.2) or the anti accelerator pedal (99.2) in a hinged manner.

67. Double pedal device according to one of the claims 49 to claim 66, characterized in that the driver's side accelerator pedal hydraulic means has an actuator means (10.12, 10.22) on the driver's side of the vehicle which is engaged in the driver's side accelerator pedal wherein the actuator means (10.12, 10.22) has at least one pressure cylinder means (11.2, 18.2).

68. Double pedal device according to claim 67, characterized in that the driver's side actuator means has an accelerator actuator (10.22) for increasing acceleration or gas and an anti acceleration actuator (10.12) for decreasing acceleration or gas.

69. Double pedal device according to claim 68, characterized in that the driver's side accelerator pedal (95.2) is moveable between a zero acceleration or gas position, in which the acceleration pedal or gas is not operated, and a full acceleration or gas position, in which full acceleration is operated, that the anti accelerator actuator (10.12) moves the driver's side accelerator pedal (95.2) in the direction from full acceleration position to the zero acceleration position if the passenger's side anti accelerator pedal (99.2) is operated, and that the accelerator actuator (10.22) moves the driver's side accelerator pedal (95.2) in the direction from the zero acceleration position to the full accelerator position if the passenger's side accelerator pedal (97.2) is operated.

70. Double pedal device according to claim 69, characterized in that the anti accelerator actuator (10.12) and the accelerator actuator (10.22) have moveable catch means (15.12, 15.22), respectively, and driver's side pressure cylinder means, respectively, and that the catch means is driven by the driver's side pressure cylinder means wherein the catch means engage in the driver's side accelerator pedal (95.2).

71. Double pedal device according to claim 69 or claim 70, characterized in that the anti accelerator actuator (10.12) and the accelerator actuator (10.22) have at least one spring (16.2, 16.12), respectively, the spring force thereof is opposed to the force of the corresponding pressure cylinder means.

72. Instructor's post for use in a driving school vehicle, particularly a truck or a bus, comprising an instructor's seat (1.5) in the cap (10.5) of the driving school vehicle, instructor's side pedal means (80.5) to be operated by the instructor, the pedal means (80.5) being coupled to a driver's side pedal means for controlling the driver's side pedal means and both of the pedal means form a double pedal device, characterized in that a distance (A5) between the instructor's seat (81.5) and the instructor's side pedal means (80.5) is adjustable.

73. Instructor's post according to claim 72, characterized in that the instructor's seat (1.5) and/or the pedal means (80.5) are arranged in the cap of the driving school vehicle so that they can be offset relatively to each other in a longitudinal direction of the driving school vehicle in order to alter the distance (A5) between the instructor's seat and the pedal means.

74. Instructor's post according to claim 72 or claim 73, characterized in that the instructor's seat is arranged on rails or in grooves extending in parallel to each other and that it is shiftable on them.

75. Instructor's post according to one of the claims 72 to 74, characterized in that the instructor's seat has a seat surface (7.5) that is above a seat surface of the driver's seat in height.

76. Instructor's post according to one of the claims 72 to 75, characterized in that the instructor's seat (1.5) has a seat member (31.5) and a pneumatic spring or suspension means (5.5) on which the seat member (31.5) is supported.

77. Instructor's post according to one of the claims 72 to 76, characterized in that the instructor's seat (1.5) has height adjusting means for adjusting the height of the instructor's seat (1.5) above the bottom chassis group (9.5) of the driving school vehicle.

78. Instructor's post according to one of the claims 72 to 77, characterized in that the instructor's seat (1.5) has a backrest member (2.5) and pivot means for adjusting the inclination of the backrest member (2.5) in relation to the seat surface (7.5) of the seat member (31.5).

79. Instructor's post according to one of the claims 72 to 78, characterized in that the instructor's side pedal means (80.5) is coupled to the driver's side pedal means (90.5) by means of hydraulic means.

80. Instructor's post according to claim 79, characterized in that the hydraulic means has at least one flexible pressure line (90, 91, 92).

81. Instructor's post according to one of the claims 72 to 80, characterized in that the instructor's seat (1.5) has a holding device (12.5) to which the instructor's side pedal means (80.5) is attached to.

82. Instructor's post according to claim 81, characterized in that the holding device (12.5) has means (17.5, 18.5) for adjusting the distance (A5) between the instructor's seat (1.5) and the instructor's side pedal means (80.5).

83. Instructor's post according to claim 82, characterized in that the instructor's side pedal means is moveable on the holding device to adjust the distance between the instructor's seat and the instructor's side pedal means.

84. Instructor's post according to one of the claims 72 to 83, characterized in that the holding device (12.5) of the instructor's side pedal means (80.5) is fixed to a a seat member (31.5) of the instructor's seat (1.5).

85. Instructor's post according to claim 84, characterized in that the instructor's side pedal means (80.5) has a casing and that the holding means (12.5) has two guides (17.5, 18.5) extending in parallel to each other, in which the pedal means (80.5) having the casing is moveable and lockable.

86. Instructor's post according to claim 85, characterized in that the instructor's side pedal means (80.5) is insertable in the guides (17.5, 18.5) and removable therefrom.

87. Instructor's post according to one of the claims 72 to 86, characterized in that the instructor's post has a display device (15.5) that shows the instructor lateral surroundings of the driving school vehicle and/or surroundings on the back of the driving school vehicle.

88. Instructor's post for a driving school vehicle, particularly a truck or a bus, comprising an instructor's seat (1.5) in the cap (10.5) of the driving school vehicle, instructor's side pedal means (80.5) to be operated by the instructor, the pedal means (80.5) being coupled to a driver's side pedal means (90.5) for controlling the driver's side pedal means (90.5) and forming a double pedal device together with the driver's pedal means,
characterized by
a display device (15.5) showing the instructor at least one view of the surroundings of the driving school vehicle.

89. Instructor's post according to claim 88, characterized in that the display device (15.5) shows the instructor a left side and/or right side and/or back side and/or frontal view of surroundings of the driving school vehicle.

90. Instructor's post according to claim 89, characterized in that the display device has a plurality of display fields each showing a view of surroundings of the driving school vehicle.

91. Instructor's post according to one of the claims 88 to 90, characterized in that the instructor's post has coupling means (13.5) that couple the display device to a video camera or a plurality of video cameras being attached to the driving school vehicle that detect the view or views of surroundings of the driving school vehicle to display the views of surroundings on the display device.

92. Instructor's post according to one of the claims 88 to 91, characterized in that the display device is attached to the instructor's seat.

93. Instructor's post according to claim 92, characterized in that the instructor's side pedal means (80.5) is attached to a seat member (31.5) of the instructor's seat by means of a holding device (12.5) and that the display device (15.5) is attached to a display holding device (12.5) which is attached to the holding device (12.5) of the instructor's side pedal means (80.5).

94. Instructor's post for a driving school vehicle, particularly a truck or a bus, comprising an instructor's seat (1.5) in the cap (10.5) of the driving school vehicle, the instructor's seat (1.5) is arranged or fixed in a middle area between a driver's seat and a passenger's seat on the base group of the driving school vehicle.

95. Instructor's post for a driving school vehicle, particularly a truck or a bus, comprising instructor's side pedal means (80.5) to be operated by the instructor, the pedal means (80.5) being coupled to a driver's side pedal means (90.5) for controlling the driver's side pedal means (90.5), which together form a double pedal device, and comprising at least one pedal (99), characterized in that
a footrest (7.6) for the instructor is provided which is arranged in an area above the pedal (99).

96. Instructor's post according to claim 95, characterized in that the footrest (7.6) is arranged with distance from the pedals in horizontal direction away from the instructor.

97. Instructor's post according to claim 95 or claim 96, characterized in that the footrest (7.6) comprises a rest tube (71.6) extending horizontally.

98. Instructor's post according to one of the claims 95 to 97, characterized in that the instructor's side pedal means (80.5) is attached to a vertical inner cover (43.6) or a vertical portion of chassis by means of a holding device (1.6).

99. Instructor's post according to claim 98, characterized in that the holding device (1.6) comprises a frame having two vertical bars (6.6, 6.16) extending in parallel and in distance to each other, a base plate (2.6) on which the vertical bars (6.6, 6.16) stand perpendicularly, and a grip portion (12.6) wherein the vertical bars (6.6, 6.16) extend between the base plate (2.6) and the grip portion (12.6), the footrest (7.6), and an attachment frame (10.6, 11.6) for attaching the pedal means (80.5) to the holding device (1.6).

100. Instructor's post according to claim 99, characterized in that the attachment frame (10.6, 11.6) is inclined relative to the plane of the vertical bars (6.6, 6.16) and towards an instructor's seat (30.6) and that an angle is formed between the attachment frame and the vertical bars.

101. Instructor's post for a driving school vehicle, particularly a truck or bus, comprising an instructor's side control unit (20.6) that is coupled to electrical installations of the driving school vehicle for controlling of the driving operation.

102. Instructor's post according to claim 101, characterized in that the control unit (20.6) has a controlling stick or joy stick.

103. Instructor's post according to claim 102, characterized in that the control unit (20.6) comprises a control stick (20.16) having a grip (21.6) and a control knob (22.6), an angled member, and an attachment member (25.6) wherein the control knob (20.16) is coupled to one end of the angled member (24.6), wherein the angled member is coupled to the attachment member with its other end, and wherein the attachment member is coupled to the driving school vehicle, and coupling means (23.6) for coupling the control unit (20.6) to the electrical facility of the driving school vehicle.

104. Instructor's post according to one of the claims 101 to 103, characterized in that the control unit (20.6) and/or the attachment member (25.6) is rigidly attached to an instructor's seat (30.6) of the instructor's post.

105. Instructor's post according to claim 103 or claim 104, characterized in that the control unit (20.6) or its control knob (22.6) has one switch or a plurality of switches (26.6) or electrical operation means for electrical switching of functions of the electrical installations of the driving school vehicle.

106. Instructor's post according to claim 105, characterized in that the switches (26.6) or the electrical operation means of the control unit (20.6) are connected or coupled to the electrical installations of the driving school vehicle via the coupling means (23.6).

107. Instructor's post according to claim 106, characterized in that the coupling means (23.6) are a cable.

108. Instructor's post according to claim 107, characterized in that the coupling means (23.6) are a telemetric device.

109. Instructor's post according to one of the claims 101 to 108, characterized in that the control unit (20.6) is attached to an instructor's seat (30.6) of the instructor's post.

110. Instructor's post according to one of the claims 101 to 109, characterized in that the control stick (20.16) of the control unit (20.6) is arranged near the free end of an armrest (32.6) of the instructor's seat so that the instructor is able to grasp by hand the grip (21.6) of the control stick (20.16) and, particularly, to reach the switch (26.6) with the thumb if the forearm rests.

111. Instructor's post according to one of the claims 101 to 110, characterized in that a display device is attached to the control unit (20.6).

112. Instructor's post according to claim 111, characterized in that the display device is coupled to a video camera on the driving school vehicle via further coupling means.

113. Instructor's post according to claim 111 or claim 112, characterized in that the display device is attached to the control knob (22.6) of the control stick (20.16) of the control unit (20.6) or a top side of the control knob.

114. Instructor's post for a driving school vehicle, particularly a truck or a bus, comprising instructor's side pedal means (80.5) to be operated by the instructor, the pedal means being coupled to a driver's side pedal means (90.5) for controlling the driver's side pedal means (90.5), the pedal means forming a double pedal device, and wherein a pedal linkage (60, 61) of the pedal means (80.5) is covered by a flexible cover (601, 602) being folded.

115. Instructor's post according to claim 114, characterized in that the cover (601, 602) is made of elastic rubber or india-rubber.

116. Driving school vehicle having a double pedal device according to one of the claims 1 to 26 and/or at least one pedal unit according to one of the claims 27 to 39 and/or at least one actuator according to one of the claims 43 to 48 an/or an instructor's post according to one of the claims 72 to 87 and/or an instructor's post according to one of the claims 88 to 115.

117. Driving school vehicle having a double pedal device according to one of the claims 49 to 71 and/or at least one pedal unit according to one of the claims 27 to 39 and/or at least one actuator according to one of the claims 40 to 42 and/or an instructor's post according to one of the claims 72 to 87 and/or an instructor's post according to one of the claims 88 to 115.
